(19) United States
(12) Patent Application Publication
(10) Pub. No.: US 2026/0265422 A1
(43) Pub. Date: Sep. 10, 2026

(54) HYDROCARBON RESIN POLYMER, MANUFACTURING METHOD THEREOF, RESIN COMPOSITION, CURABLE COMPOSITE MATERIAL, CURED RESIN BODY, AND RESIN PRODUCT

(71) Applicant: LCY CHEMICAL CORP., Kaohsiung City (TW)

(72) Inventors: Ming-Hung LIAO, Kaohsiung City (TW); Ka Chun AU-YEUNG, Kaohsiung City (TW); Yu-Pin LIN, Kaohsiung City (TW); Wei-Liang LEE, Kaohsiung City (TW); Tzu-Yin HUANG, Kaohsiung City (TW); Tz-Jie JU, Kaohsiung City (TW); Yi-Hsuan TANG, Kaohsiung City (TW); Yu-Tien CHEN, Kaohsiung City (TW); Yu-Chen HSU, Kaohsiung City (TW)

(21) Appl. No.: 19/550,483

(22) Filed: Feb. 26, 2026

Related U.S. Application Data
(60) Provisional application No. 63/763,442, filed on Feb. 26, 2025.

(30) Foreign Application Priority Data
Feb. 6, 2026 (TW) 115104802

(51) Int. Cl. C08F 12/34

(52) U.S. Cl. CPC C08F 12/34

(57) ABSTRACT

A hydrocarbon resin polymer includes a structural unit (A) represented by the following Formula (I) or Formula (II); a structural unit (B) derived from a monovinyl aromatic compound; and a structural unit (C) derived from a divinyl aromatic compound.

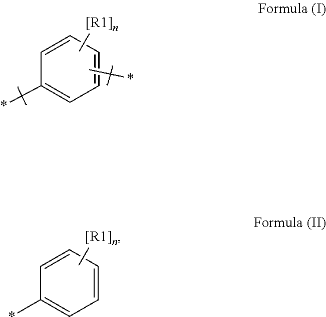

In chemical formulae (I) and (II), R1 represents a C₁₋₄ alkyl group or a C₁₋₄ alkoxy group; n is an integer of 0 to 3; and * represents a connecting site that connects other groups or units.

### CROSS REFERENCE TO RELATED APPLICATIONS

This application claims the benefit of U.S. provisional application No. 63/763,442, filed Feb. 26, 2025, the entirety of which is incorporated by reference herein.

This application claims priority of Taiwan patent application No. 115104802, filed Feb. 6, 2026, the entirety of which is incorporated by reference herein.

### TECHNICAL FIELD

The present disclosure relates to a resin polymer, a manufacturing method thereof, and a resin composition, a curable composite material, a cured resin body, and a resin product including the same, and, in particular, to a hydrocarbon resin polymer, a manufacturing method thereof, and a resin composition, a curable composite material, a cured resin body, and a resin product including the same.

### BACKGROUND

Fifth generation mobile communication technology (5th generation mobile networks, or 5G) is the latest generation of mobile communication technology. The 5G mobile communication technology features high-speed transmission, wide connection, and low latency. There are three types of 5G mobile communication technology, depending on the frequency band that is used: high-frequency 5G, intermediate-frequency 5G, and low-frequency 5G. High-frequency 5G can provide ultra-high connection rates.

However, during transmission, high-frequency 5G can be affected by signal transmission and reception due to high-frequency path loss, conductor loss, and dielectric loss. Therefore, it is necessary to develop a material for copper clad laminate (CCL) having low dielectric loss to reduce dielectric loss of high-frequency 5G during transmission, thereby enhancing the quality of signal transmission and reception.

In order to manufacture copper clad laminates, resin polymers having high solubility and good processability are required, so that the resin polymers exhibit appropriate flowability and processability during the CCL fabrication process. This enhances process stability and production yield, and helps achieve copper clad laminates with uniform thickness, good interlayer adhesion, and stable quality.

### SUMMARY

In view of the above issues, the present disclosure provides a hydrocarbon resin polymer having high solubility and/or good processability and a manufacturing method thereof. A resin composition including the hydrocarbon resin polymer of the present disclosure may also have high solubility and/or good processability. Further, in some embodiments, the hydrocarbon resin polymer of the present disclosure has good electrical performance. A resin composition, a curable composite material, a cured resin body, and a resin product including the hydrocarbon resin polymer of the present disclosure may also have good electrical performance. In other embodiments, the hydrocarbon resin polymer of the present disclosure has good thermal performance. A resin composition, a curable composite material, a cured resin body, and a resin product including the hydrocarbon resin polymer of the present disclosure may have good thermal performance. In still other embodiments, a resin composition including the hydrocarbon resin polymer of the present disclosure may form a cured resin body having good peel strength, thereby enhancing the reliability of resin products including the cured resin body.

In some embodiments, the present disclosure provides a hydrocarbon resin polymer, including a structural unit (A) represented by the following Formula (I) or Formula (II); a structural unit (B) derived from a monovinyl aromatic compound; and a structural unit (C) derived from a divinyl aromatic compound.

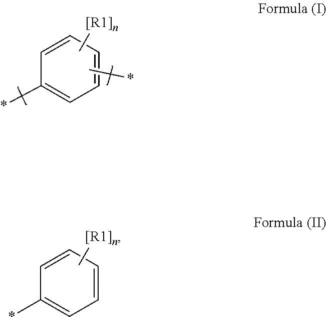

wherein R1 in Formula (I) and Formula (II) is a C₁₋₄ alkyl group or a C₁₋₄ alkoxy group; n is an integer selected from 0 to 3; and * represents a connecting site connected to another group or unit.

In some embodiments, the present disclosure provides a method for manufacturing a hydrocarbon resin polymer, including performing a polymerization process to form a hydrocarbon resin polymer from a mixture, wherein the mixture includes a monovinyl aromatic compound, a divinyl aromatic compound, and a compound represented by the following Formula (III),

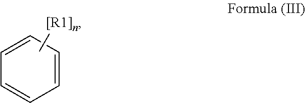

wherein R1 in Formula (III) is a C₁₋₄ alkyl group or a C₁₋₄ alkoxy group, and n is an integer selected from 0 to 3.

In some embodiments, the present disclosure provides a resin composition, including the above-mentioned hydrocarbon resin polymer.

In some embodiments, the present disclosure provides a curable composite material, including the above-mentioned hydrocarbon resin polymer.

In some embodiments, the present disclosure provides a cured resin body formed from the above-mentioned hydrocarbon resin polymer.

In some embodiments, the present disclosure provides a resin product, including the above-mentioned cured resin body.

### BRIEF DESCRIPTION OF THE DRAWINGS

The present invention can be more fully understood by reading the subsequent detailed description and examples with references made to the accompanying drawings, wherein:

FIG. 1 is a ¹H-NMR spectrum of a hydrocarbon resin polymer according to an embodiment of the present disclosure;

FIG. 2 is a ¹³C-NMR spectrum of a hydrocarbon resin polymer according to an embodiment of the present disclosure;

FIG. 3 is a ¹H-NMR spectrum of a hydrocarbon resin polymer according to an embodiment of the present disclosure;

FIG. 4 is a ¹³C-NMR spectrum of a hydrocarbon resin polymer according to an embodiment of the present disclosure;

FIG. 5 is a ¹H-NMR spectrum of a hydrocarbon resin polymer according to an embodiment of the present disclosure;

FIG. 6 is a ¹³C-NMR spectrum of a hydrocarbon resin polymer according to an embodiment of the present disclosure; and

FIG. 7 is a ¹⁹F-NMR spectrum of a hydrocarbon resin polymer according to an embodiment of the present disclosure.

### DETAILED DESCRIPTION

It will be further understood that when “including” and/or “comprising” are used in this specification, they particularly refer to the existence of the described features, integers, steps, operations, elements, components, and/or groups thereof, but do not exclude the existence or addition of one or more other features, integers, steps, operations, elements, components, and/or groups thereof. When the singular forms “a” and “an” are used in this specification, it is intended to include the plural forms as well, unless the context clearly indicates otherwise.

It will be understood that although the terms “first”, “second”, and the like, may be used herein to describe various steps, elements, components, regions, layers and/or portions, these steps, elements, components, regions, layers and/or portions should not be limited by these terms. These terms are only used to distinguish one step, element, component, region, layer or portion from another step, element, component, region, layer or portion.

It is to be understood that the terms “about,” “approximately,” and “substantially” as used herein generally indicate within 20% of a given value or range, preferably within 10%, and more preferably within 5%, or within 3%, or within 2%, or within 1%, or within 0.5%. A given quantity herein is an approximate quantity, that is, even in the absence of explicit recitation of “about,” “approximately,” or “substantially,” the meaning of “about,” “approximately,” or “substantially” is still implicitly included. Further, numerical values expressed in the present disclosure may include the stated values and deviation values within a deviation range acceptable to a person having ordinary skill in the art. It is to be understood that the expression “a to b” or “a-b” used herein to express a specific numerical range is defined as “≥a and ≤b.”

Unless defined otherwise, all technical and scientific terms used herein have the same meaning as commonly understood by one of ordinary skill in the art to which this disclosure belongs. It will be understood that these terms, for example, terms defined in commonly used dictionaries, should be interpreted as having meanings consistent with the relevant art and the background or context of the present disclosure, and should not be interpreted in an idealized or overly formal manner, unless specifically defined in the embodiments of the present disclosure. Descriptions that may unnecessarily obscure known functions and structures of the present disclosure will be omitted below.

As used herein, “C₁₋₄ alkoxy” refers to a group having a —O—C₁₋₄ alkyl or —C₁₋₄ alkyl-O structure. As used herein, “C₁₋₄ alkyl” refers to a linear, branched, or cyclic aliphatic hydrocarbon monovalent group having 1 to 4 carbon atoms on the main carbon chain. Examples of C₁₋₄ alkyl may include methyl, ethyl, propyl, isobutyl, sec-butyl, and tert-butyl, but the present disclosure is not limited thereto.

As used herein, “C₁₋₂₀ alkyl” refers to a linear, branched, or cyclic aliphatic hydrocarbon monovalent group having 1 to 20 carbon atoms on the main carbon chain. Examples of C₁₋₂₀ alkyl may include methyl, ethyl, propyl, isobutyl, sec-butyl, tert-butyl, pentyl, isopentyl, hexyl, decyl, dodecyl, cyclohexyl, cyclooctyl, and cyclododecyl, but the present disclosure is not limited thereto.

As used herein, the “C₂₋₆₀ alkenyl” refers to a linear, branched, or cyclic aliphatic hydrocarbon monovalent group having 2 to 60 carbon atoms on the main carbon chain and at least one carbon-carbon double bond. As used herein, the “C₂₋₂₀ alkenyl” refers to a linear, branched, or cyclic aliphatic hydrocarbon monovalent group having 2 to 20 carbon atoms on the main carbon chain and at least one carbon-carbon double bond. Examples of the C₂₋₆₀ alkenyl may include, but are not limited to, vinyl, propenyl, isobutenyl, sec-butenyl, tert-butenyl, pentenyl, isopentenyl, hexenyl, decenyl, dodecenyl, pentadecenyl, cyclohexenyl, cyclooctenyl, cyclopentenyl, cyclopentadienyl, cyclopentadecenyl, 1,2-dihydronaphthalene, bicyclodecene, norbornene, and dicyclopentadiene, but the present disclosure is not limited thereto.

Some embodiments of the present disclosure provide a hydrocarbon resin polymer, including a structural unit (A) represented by the following Formula (I) or Formula (II); a structural unit (B) derived from a monovinyl aromatic compound; and a structural unit (C) derived from a divinyl aromatic compound.

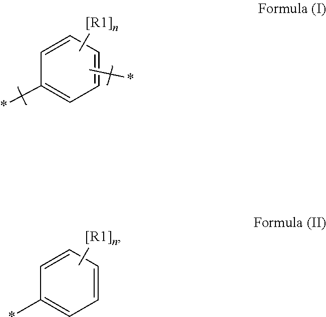

R1 in Formula (I) and Formula (II) is a C₁₋₄ alkyl group or a C₁₋₄ alkoxy group; n is an integer selected from 0 to 3; and * represents a connecting site connected to another group or unit. In some embodiments, R1 in Formula (I) and Formula (II) is selected from the group consisting of methyl, ethyl, isopropyl, tert-butyl, methoxy, and ethoxy. In some embodiments, R1 in Formula (I) and Formula (II) is a C₁₋₄ alkyl group.

In some embodiments, Formula (I) and Formula (II) are derived from an aromatic compound having a dielectric constant of less than 4. That is, in some embodiments, the structural unit (A) may be derived from an aromatic compound having a dielectric constant of less than 4. In such embodiments, the hydrocarbon resin polymer of the present disclosure may have improved electrical performance. In some embodiments, Formula (I) and Formula (II) are derived from a compound represented by Formula (III), but the present disclosure is not limited thereto.

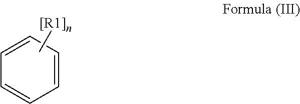

R1 in Formula (III) is a C₁₋₄ alkyl group or a C₁₋₄ alkoxy group, and n is an integer selected from 0 to 3. In some embodiments, R1 in Formula (III) is a C₁₋₄ alkyl group. In some embodiments, the compound represented by Formula (III) may be selected from the group consisting of benzene, toluene, xylene, ethylbenzene, methoxybenzene, isopropylbenzene, tert-butylbenzene, 1,2,3-trimethylbenzene, 1,2,4-trimethylbenzene, and 1,3,5-trimethylbenzene (mesitylene), but the present disclosure is not limited thereto.

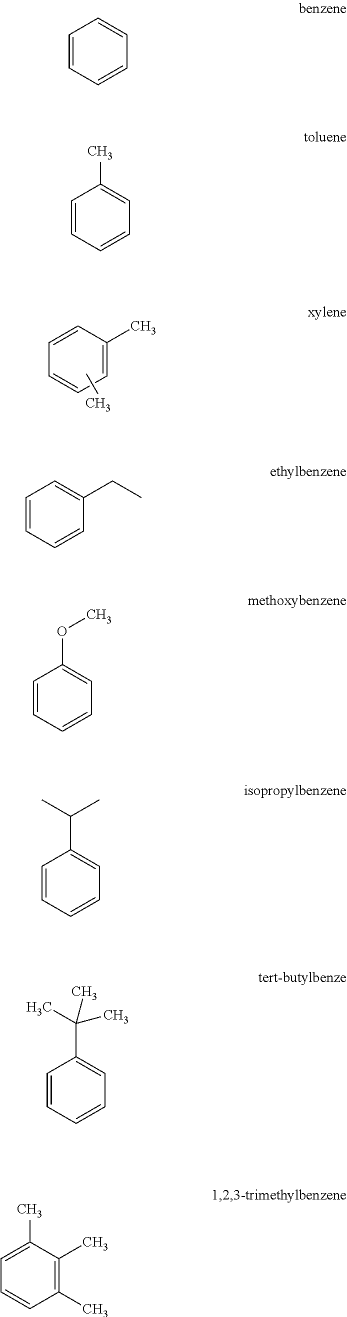

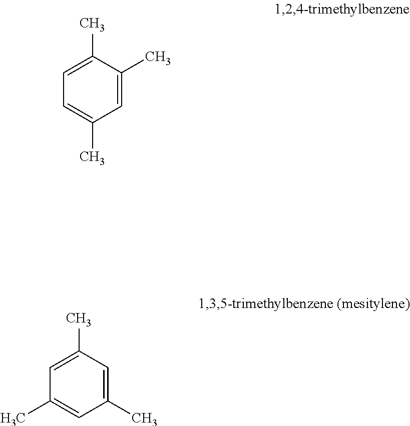

In some embodiments, based on 100 mol % of the total amount of all units in the hydrocarbon resin polymer, the content of the structural unit (A) is 0.01 to 10 mol %. The content of the structural unit (A) described herein can be calculated by ¹H NMR and ¹³C NMR. Within the above content range, the structural unit (A) is derived from an aromatic compound, and the aromatic structure introduced thereby can provide the hydrocarbon resin polymer with good compatibility with commonly used organic solvents, thereby enhancing solubility of the hydrocarbon resin polymer in solvents and facilitating flowability and processability of a resin composition during processing. In addition, the aromatic structure introduced by the structural unit (A) also helps regulate the polarity and electronic structure distribution of the hydrocarbon resin polymer, such that the hydrocarbon resin polymer exhibits good dielectric performance. When the content of the structural unit (A) falls within the above range, the structural unit (A) can jointly contribute with other structural units (for example, structural unit (B) and structural unit (C)) within the overall formulation, such that the hydrocarbon resin polymer has excellent electrical performance, thermal performance, solubility, and processability, among others. Further, a resin composition including the same can form a cured resin body having good peel strength. In some embodiments, based on 100 mol % of the total amount of all units in the hydrocarbon resin polymer, the content of the structural unit (A) may be 0.05 to 10 mol %, 0.1 to 10 mol %, 0.1 to 6.5 mol %, 0.1 to 5 mol %, 0.8 to 10 mol %, or 0.2 to 3 mol %. Preferably, in some embodiments, based on 100 mol % of the total amount of all units in the hydrocarbon resin polymer, the content of the structural unit (A) may be <5 mol %, <4 mol %, or <3 mol %, such as 0.3 mol %, 0.4 mol %, 0.5 mol %, 2 mol %, or 3 mol %. In some embodiments, when the content of the structural unit (A) falls within the above preferred ranges, the content of the structural unit (A) is not excessively high so as to affect contributions of other structural units, thereby enabling the hydrocarbon resin polymer to have, for example, improved electrical performance, thermal performance, solubility, and/or processability, among others.

As used herein, the monovinyl aromatic compound refers to a compound including a carbocyclic aromatic structure, in which one hydrogen on a ring-forming carbon atom of the carbocyclic aromatic structure is substituted by a vinyl group. In some embodiments, the vinyl group may be unsubstituted. In some embodiments, at least one hydrogen on the vinyl group may be substituted by a C₁₋₂₀ alkyl group. In some embodiments, the carbocyclic aromatic structure may include 6 to 60 or 6 to 20 ring-forming carbon atoms.

In some embodiments, at least another hydrogen on a ring-forming carbon atom in the carbocyclic aromatic structure may be substituted by a C₁₋₂₀ alkyl group. Examples of the monovinyl aromatic compound may include styrene, methylstyrene, α-methylstyrene, or ethylstyrene, but the present disclosure is not limited thereto.

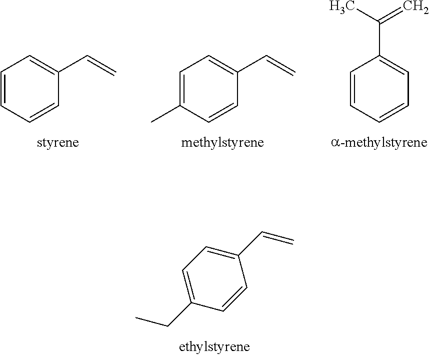

In some embodiments, the structural unit (B) derived from the monovinyl aromatic compound includes a carbocyclic aromatic structure from the monovinyl aromatic compound. For example, in some embodiments, the structural unit (B) may have the following structures, but the present disclosure is not limited thereto:

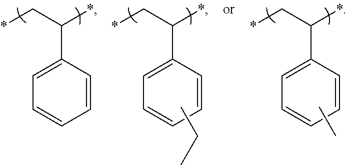

In the above structures, “*” represents a connecting site connected to another group or unit.

In some embodiments, based on 100 mol % of the total amount of all units in the hydrocarbon resin polymer, the content of the structural unit (B) is 15 to 95 mol %. The content of the structural unit (B) described herein can be calculated by ¹H NMR and ¹³C NMR. The structural unit (B) has a carbocyclic aromatic structure, and the aromatic backbone introduced thereby can provide the hydrocarbon resin polymer with good compatibility with organic solvents, thereby enhancing solubility of the hydrocarbon resin polymer in solvents and contributing to the dispersibility and processability of the resin composition during manufacturing. When the content of the structural unit (B) is within the above range, the structural unit (B) is configured together with other structural units, such that the hydrocarbon resin polymer of the present disclosure can have good electrical performance, good thermal performance, high solubility, and/or good processability. Further, a resin composition including the same can form a cured resin body having good peel strength. In some embodiments, based on 100 mol % of the total amount of all units in the hydrocarbon resin polymer, the content of the structural unit (B) may be 16.5 to 94.5 mol %, 30 to 94 mol %, 40 to 93 mol %, or 50 to 90 mol %. In some embodiments, based on 100 mol % of the total amount of all units in the hydrocarbon resin polymer, the content of the structural unit (B) may be 16 mol %, 17 mol %, 18 mol %, 20 mol %, 80 mol %, 75 mol %, 70 mol %, or 65 mol %.

As used herein, the divinyl aromatic compound refers to a compound including at least one carbocyclic aromatic structure and having at least two vinyl substituents in the overall molecule, wherein the vinyl substituents are connected to ring-forming carbon atoms of one or more carbocyclic aromatic structures. In some embodiments, the vinyl groups may be unsubstituted. In some embodiments, at least one hydrogen on the vinyl groups may be substituted by a C₁₋₂₀ alkyl group. In some embodiments, the carbocyclic aromatic structures may include 6 to 60 or 6 to 20 ring-forming carbon atoms. In some embodiments, at least another hydrogen on a ring-forming carbon atom of the carbocyclic aromatic structure may be substituted by a C₁₋₂₀ alkyl group. Examples of the divinyl aromatic compound may include divinylbenzene (DVB), 1,3-diisopropenylbenzene, 1,2-bis(4-vinylphenyl) ethane (BVPE), and p-isopropenyl-α-methylstyrene (IPAMS), but the present disclosure is not limited thereto.

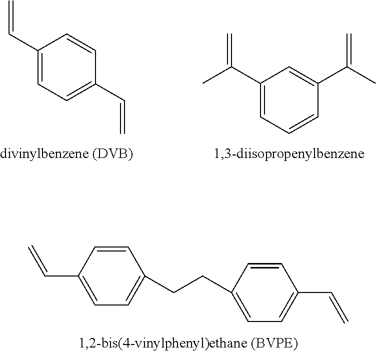

In some embodiments, the structural unit (C) derived from the divinyl aromatic compound includes a carbocyclic aromatic structure from the divinyl aromatic compound. In some embodiments, the structural unit (C) may include a crosslinkable structural unit (C1) and a crosslinked structural unit (C2):

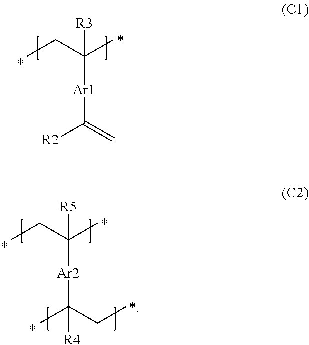

R2, R3, R4, and R5 in the crosslinkable structural unit (C1) and the crosslinked structural unit (C2) are each independently H or a C₁₋₂₀ alkyl group; Ar1 and Ar2 are each a divalent group having a carbocyclic aromatic structure, such as phenylene, biphenylene, or a divalent aromatic group formed by bridging aromatic rings via an alkylene group; and * represents a connecting site of the crosslinkable structural unit (C₁) and/or the crosslinked structural unit (C2) connected to another group or unit. In some embodiments, the crosslinkable structural unit (C1) may include the following structure, but the present disclosure is not limited thereto:

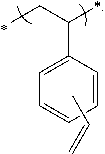

In some embodiments, the crosslinked structural unit (C2) may include the following structure, but the present disclosure is not limited thereto:

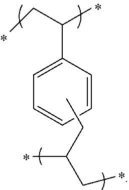

In some embodiments, based on 100 mol % of the total amount of all units in the hydrocarbon resin polymer, the content of the structural unit (C) is 1 to 80 mol %. The content of the structural unit (C) described herein can be calculated by 1H NMR and ¹³C NMR. When the content of the structural unit (C) is within the above range, it provides the hydrocarbon resin polymer with the desired degree of crosslinking. In this configuration, the crosslinked structures formed by the structural unit (C) facilitates enhancement of thermal performance, thermal stability, and electrical performance of the hydrocarbon resin polymer, while still maintaining required solubility and processability of the resin during manufacturing. Further, a resin composition including the same can form a cured resin body having good peel strength. In some embodiments, based on 100 mol % of the total amount of all units in the hydrocarbon resin polymer, the content of the structural unit (C) may be 3 to 70 mol %, 5 to 60 mol %, or 10 to 50 mol %. In some embodiments, based on 100 mol % of the total amount of all units in the hydrocarbon resin polymer, the content of the structural unit (C) may be 1.5 mol %, 2 mol %, 4 mol %, 8 mol %, 12 mol %, 15 mol %, 18 mol %, 20 mol %, 25 mol %, 35 mol %, or 45 mol %.

In some embodiments, based on 100 mol % of the total amount of all units in the hydrocarbon resin polymer, the hydrocarbon resin polymer may include 1 to 30 mol % of the crosslinkable structural unit (C1). When the content of the crosslinkable structural unit (C1) in the hydrocarbon resin polymer is within the above range, the hydrocarbon resin polymer can have good thermal performance, electrical performance, and/or processability. In some embodiments, based on 100 mol % of the total amount of all units in the hydrocarbon resin polymer, the hydrocarbon resin polymer may include 3 to 28 mol %, 5 to 25 mol %, or 6 to 22 mol % of the crosslinkable structural unit (C1). In some embodiments, based on 100 mol % of the total amount of all units in the hydrocarbon resin polymer, the content of the crosslinkable structural unit (C1) may be 1.5 mol %, 2 mol %, 2.5 mol %, 4 mol %, 7 mol %, 8 mol %, 10 mol %, 15 mol %, 18 mol %, 26 mol %, or 29 mol %.

In some embodiments, the hydrocarbon resin polymer of the present disclosure may further include a structural unit (D) being a first structural unit (D1) and/or a second structural unit (D2). The first structural unit (D1) is derived from a cyclic olefin compound or a non-alkenyl-substituted aromatic compound. The second structural unit (D2) is derived from a linear olefin compound or a branched olefin compound.

As used herein, the non-alkenyl-substituted aromatic compound refers to a compound including a carbocyclic aromatic structure. As used herein, the non-alkenyl-substituted aromatic compound of the present disclosure refers to an aromatic compound whose substituent is not an alkenyl group. The non-alkenyl-substituted aromatic compound of the present disclosure may be a substituted or unsubstituted aromatic compound, as long as the substituent thereof is not an alkenyl group. In some embodiments, the non-alkenyl-substituted aromatic compound may be a polycyclic aromatic compound, for example, a carbocyclic aromatic compound including two or more fused aromatic rings. In some embodiments, the non-alkenyl-substituted aromatic compound may be an aromatic compound in which at least one hydrogen atom on a ring-forming carbon atom of the carbocyclic aromatic structure is substituted with a C₁₋₂₀ alkyl. In some embodiments, the carbocyclic aromatic structure may include 6 to 60 or 6 to 20 ring-forming carbon atoms. Examples of the non-alkenyl-substituted aromatic compound may include indene, methyl indene, naphthalene, or methyl naphthalene, but the present disclosure is not limited thereto.

The cyclic olefin compound may be a C₃₋₆₀ alkenyl compound. The cyclic olefin compound refers to a hydrocarbon compound in which carbon atoms are connected to each other to form a closed non-aromatic carbocyclic structure, and the non-aromatic carbocyclic structure includes at least one carbon-carbon double bond (C═C). In some embodiments, the non-aromatic carbocyclic structure may include a polycyclic structure or a bridged ring structure. In some embodiments, at least another hydrogen on a ring-forming carbon atom of the carbocyclic structure may be substituted with a C₁₋₂₀ alkyl or a C₂₋₂₀ alkenyl. Examples of the cyclic olefin compound may include cyclopentene, cyclohexene, dicyclopentadiene, norbornene, ethylidene-norbornene (ENB), vinyl norbornene, or norbornadiene, but the present disclosure is not limited thereto.

In some embodiments, the first structural unit (D1) may have the following structures, but the present disclosure is not limited thereto:

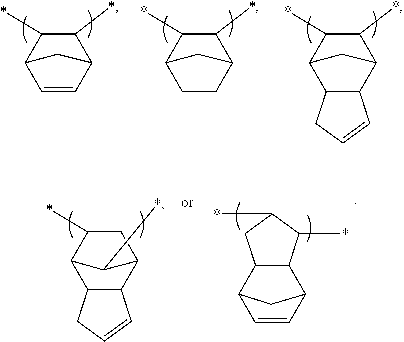

In the above structures, * represents a connecting site connected to another group or unit. Compared with the second structural unit (D2), the first structural unit (D1) has higher rigidity; therefore, the glass transition temperature of the hydrocarbon resin polymer may be increased or the thermal performance of the hydrocarbon resin polymer may be enhanced.

The linear olefin compound may be a C₂₋₆₀ alkenyl compound. The linear olefin compound refers to a hydrocarbon compound having a main carbon chain in which carbon atoms are not connected end-to-end and are arranged in a linear form (without branching), and the main carbon chain includes at least one carbon-carbon double bond. In some embodiments, at least another hydrogen on the main carbon chain of the linear olefin compound may be substituted with a C₁₋₂₀ alkyl or a C₂₋₂₀ alkenyl. Examples of the linear olefin compound may include ethylene, propylene, 1-butene, and butadiene, but the present disclosure is not limited thereto.

The branched olefin compound may be a C₂₋₆₀ alkenyl compound. The branched olefin compound refers to a hydrocarbon compound in which carbon atoms are not connected end-to-end and includes a main carbon chain arranged in a linear form and one or more side-chain carbon chains, and includes a carbon-carbon double bond. In some embodiments, at least another hydrogen on the main carbon chain and/or the side-chain carbon chain of the branched olefin compound may be substituted with a C₁₋₂₀ alkyl or a C₂₋₂₀ alkenyl. Examples of the branched olefin compound may include isobutylene, isoprene, and 2-methylhexene, but the present disclosure is not limited thereto.

In some embodiments, based on 100 mol % of the total amount of all units in the hydrocarbon resin polymer, the content of the structural unit (D) may be 0.1 to 80 mol %. The content of the structural unit (D) described herein may be calculated by 1H NMR and ¹³C NMR. As described above, the structural unit (D) may include the structural unit (D1) and the structural unit (D2). The structural unit (D1) is derived from a cyclic olefin compound or a non-alkenyl-substituted aromatic compound having higher rigidity, which may introduce a relatively rigid molecular structure, thereby facilitating enhancement of the glass transition temperature and overall thermal performance of the hydrocarbon resin polymer. On the other hand, the structural unit (D2) is derived from a linear olefin compound or a branched olefin compound, and the aliphatic structure introduced thereby may facilitate regulation of the electrical performance of the hydrocarbon resin polymer. When the content of the structural unit (D) is within the above range, the structural unit (D1) and the structural unit (D2) may be present in an appropriate proportion within the hydrocarbon resin polymer, such that the hydrocarbon resin polymer may have better thermal performance, glass transition temperature, electrical performance, and lower manufacturing cost. Further, a resin composition including the same may form a cured resin body having good peel strength. In some embodiments, based on 100 mol % of the total amount of all units in the hydrocarbon resin polymer, the content of the structural unit (D), the first structural unit (D1), and/or the second structural unit (D2) may be 0.15 to 50 mol %, 0.5 to 30 mol %, or 1 to 15 mol %. In some embodiments, based on 100 mol % of the total amount of all units in the hydrocarbon resin polymer, the content of the structural unit (D), the first structural unit (D1), and/or the second structural unit (D2) may be 2 mol %, 3 mol %, 4 mol %, 5 mol %, 6 mol %, 7 mol %, 8 mol %, 60 mol %, 75 mol %, 78 mol %, or 79 mol %.

In some embodiments, when the structural unit (C) and the structural unit (D) are incorporated at appropriate contents in the hydrocarbon resin polymer, better thermal performance and/or thermal stability of the hydrocarbon resin polymer may be provided. In some embodiments, based on 100 mol % of the total amount of all units in the hydrocarbon resin polymer, the total content of the structural unit (C) and the structural unit (D) in the hydrocarbon resin polymer may be greater than or equal to 5 mol %. In some embodiments, based on 100 mol % of the total amount of all units in the hydrocarbon resin polymer, the total content of the structural unit (C) and the structural unit (D) in the hydrocarbon resin polymer may be greater than or equal to 10 mol %, greater than or equal to 13 mol %, greater than or equal to 20 mol %, or greater than or equal to 30 mol %. In some embodiments, based on 100 mol % of the total amount of all units in the hydrocarbon resin polymer, the total content of the structural unit (C) and the structural unit (D) of the hydrocarbon resin polymer may be less than or equal to 85 mol %, less than or equal to 80 mol %, less than or equal to 70 mol %, 60 mol %, or 50 mol %.

In some embodiments, the hydrocarbon resin polymer may include reactive double bonds. As used herein, “reactive double bond” refers to a double bond in the structural unit (C) or the structural unit (D) that is capable of reacting with another compound or polymer. For example, in some embodiments, the reactive double bond includes a double bond in the following first structural unit (D1):

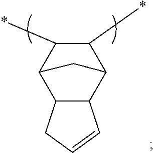

or a double bond on a non-benzene ring in the following crosslinkable structural unit (C₁):

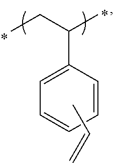

but the present disclosure is not limited thereto.

In some embodiments, a hydrogen atom content in the reactive double bonds of the hydrocarbon resin polymer may be less than 10%. In some embodiments, the hydrogen atom content in the reactive double bonds in the hydrocarbon resin polymer may be greater than 0.2%. When the hydrogen atom content in the reactive double bonds in the hydrocarbon resin polymer is less than 10%, the hydrocarbon resin polymer is less prone to oxidation during a heat curing process or tends to complete the crosslinking reaction before oxidation, thereby maintaining the good electrical performance of the hydrocarbon resin polymer. When the hydrogen atom content in the reactive double bonds in the hydrocarbon resin polymer is greater than 0.2%, a resin composition including the same may form a cured resin body having good peel strength. In some embodiments, the hydrogen atom content in the reactive double bonds in the hydrocarbon resin polymer may be 0.2% to 10%, 0.3% to 9%, 0.5% to 8%, 1% to 7%, or 3% to 7%. In some embodiments, the hydrogen atom content in the reactive double bonds in the hydrocarbon resin polymer may be 2.0%, 2.5%, 3.0%, 3.5%, 8.5%, 9.0%, or 9.5%.

In some embodiments, a number-average molecular weight (Mn) of the hydrocarbon resin polymer may be 200 to 25,000 g/mol. When the number-average molecular weight of the hydrocarbon resin polymer is within the above range, the hydrocarbon resin polymer may have good solubility. In some embodiments, the number-average molecular weight (Mn) of the hydrocarbon resin polymer may be 300 to 140,000 g/mol, 500 to 130,000 g/mol, 700 to 120,000 g/mol, or 900 to 110,000 g/mol. In some embodiments, the number-average molecular weight (Mn) of the hydrocarbon resin polymer may be 2,000 g/mol, 2,500 g/mol, 3,000 g/mol, 3,500 g/mol, 4,000 g/mol, 16,000 g/mol, 17,000 g/mol, 18,000 g/mol, or 20,000 g/mol.

In some embodiments, a weight-average molecular weight (Mw) of the hydrocarbon resin polymer may be 10,000 to 150,000 g/mol. When the weight-average molecular weight of the hydrocarbon resin polymer is within the above range, the hydrocarbon resin polymer may have good solubility, better processability, and/or good film-forming property. In some embodiments, the weight-average molecular weight (Mw) of the hydrocarbon resin polymer may be 20,000 to 140,000 g/mol, 30,000 to 130,000 g/mol, 40,000 to 120,000 g/mol, or 50,000 to 110,000 g/mol. In some embodiments, the weight-average molecular weight (Mw) of the hydrocarbon resin polymer may be 25,000 g/mol, 35,000 g/mol, 145,000 g/mol, or 135,000 g/mol.

In some embodiments, a polymer dispersity index (PDI) of the hydrocarbon resin polymer may be 1 to 50, wherein the PDI is the ratio (Mw/Mn) of the weight-average molecular weight (Mw) to the number-average molecular weight (Mn) of the hydrocarbon resin polymer. In some embodiments, the PDI of the hydrocarbon resin polymer may be 1, 3, 5, 11, 13, 15, 17, 21, 25, or 27.

In some embodiments, the hydrocarbon resin polymer may have a specific range of molecular weight distribution characteristics. To describe a degree of molecular weight distribution, a parameter Fp is defined herein as an auxiliary representation, wherein Fp is calculated according to the following formula, and the PDI is as described above:

$$Fp = 1 / PDI .$$

In some embodiments, the hydrocarbon resin polymer may have an Fp of 0.02 to 1.0. When the Fp of the hydrocarbon resin polymer is within the above range, the hydrocarbon resin polymer may have good solubility and/or better processability. In some embodiments, the Fp of the hydrocarbon resin polymer may be less than 1.5. In some embodiments, the Fp of the hydrocarbon resin polymer may be 0.1 to 1.0, 0.5 to 1.0, or 0.8 to 1.0. In some embodiments, the Fp of the hydrocarbon resin polymer may be 0.05, 0.06, 0.07, 0.08, or 0.15.

In order to characterize a structural configuration state related to rigidity and thermal properties, a parameter Rh is further defined herein as an index for describing a configuration condition of structural units related to rigidity and thermal performance in the hydrocarbon resin polymer. The Rh is calculated according to the following formula:

$$Rh = 0.9 * H + 0.1 * ( C 1 + D 1 ) ,$$

wherein H, C1, and D1 are numerical values expressed as H %, C1%, and D1%, respectively, used directly for calculation without converting the percentage values into decimal form; the Rh obtained after substituting the proportional values into the above formula is a calculated index value used to reflect relative differences among different structural configuration states, wherein H % is the hydrogen atom content in reactive double bonds of the hydrocarbon resin polymer; C1% is, based on 100 mol % of the total amount of all units in the hydrocarbon resin polymer, the content of the crosslinkable structural unit (C1); and D1% is, based on 100 mol % of the total amount of all units in the hydrocarbon resin polymer, the content of the first structural unit (D1).

For example, when a hydrogen atom content (H %) in reactive double bonds of a hydrocarbon resin polymer is 3.24%, the content of the crosslinkable structural unit (C1%) is 11 mol %, and the content of the first structural unit (D1%) is 4 mol %. Then, in this embodiment, after substituting the corresponding numerical values 3.24, 11, and 4 for H, C1, and D1, respectively, into the above formula, an Rh value of about 4.42 may be obtained.

In some embodiments, the hydrocarbon resin polymer may have an Rh of 0.5 to 15. When the Rh of the hydrocarbon resin polymer is within the above range, the hydrocarbon resin polymer may have good thermal performance and/or thermal stability. In some embodiments, the Rh of the hydrocarbon resin polymer may be greater than 3. In some embodiments, the Rh of the hydrocarbon resin polymer may be 1 to 15, 2 to 12, or 3 to 10. In some embodiments, the Rh of the hydrocarbon resin polymer may be 4, 5, 6, 7, or 8.

In order to characterize a structural configuration state related to electrical performance, a parameter Ed is further defined herein as an index for describing a configuration condition of structural units related to electrical performance in the hydrocarbon resin polymer. The Ed is calculated according to the following formula, wherein Fp is as described above:

$$Ed = 0.9 * Fp + 0.1 * Ms ,$$

wherein Ms is calculated according to the following formula:

$$Ms = ( A + B + 3 * D 2 ) / 1000 ,$$

wherein, A, B, and D2 are numerical values expressed as A %, B %, and D2%, respectively, used directly for calculation without converting the percentage values into decimal form; the Ms and Ed obtained after substituting the proportional values into the above formula are calculated index values used to reflect relative differences among different structural configuration states.
A % is the content of the structural unit (A) based on 100 mol % of the total amount of all units in the hydrocarbon resin polymer; B % is the content of the structural unit (B) based on 100 mol % of the total amount of all units in the hydrocarbon resin polymer; and D2% is the content of the second structural unit (D2) based on 100 mol % of the total amount of all units in the hydrocarbon resin polymer.

For example, when a hydrocarbon resin polymer has an Fp of 0.1984, the content (A %) of the structural unit (A) is 1 mol %, a content (B %) of the structural unit (B) is 77 mol %, and a content (D2%) of the second structural unit (D2) is 0 mol %, then, in this embodiment, after substituting A, B, and D2 into the above Ms calculation formula using the corresponding values 1, 77, and 0 in percentage form, Ms can be obtained as (1+77+3×0)/1,000=0.078. Furthermore, by substituting Fp and Ms into the above Ed calculation formula, the Ed value of about 0.1864 can be obtained.

In some embodiments, the hydrocarbon resin polymer can have an Ed of 0.02 to 0.3. When the Ed of the hydrocarbon resin polymer is within the above range, the hydrocarbon resin polymer can have good electrical performance. In some embodiments, the Ed of the hydrocarbon resin polymer can be 0.025 to 0.25, 0.03 to 0.2, or 0.04 to 0.16. In some embodiments, the Ed of the hydrocarbon resin polymer can be 0.07, 0.08, 0.1, or 0.15.

In order to characterize a structural configuration state related to peel strength performance, a parameter PL is further defined herein as an index for describing a structural parameter configuration condition related to peel strength performance in the hydrocarbon resin polymer. The PL is calculated according to the following formula, wherein Mn is a number-average molecular weight of the hydrocarbon resin polymer, and PDI and H are as described above:

$$PL = Mn * PDI * H / 100 ,$$

wherein Mn, PDI, and H are used as input parameters for calculation, wherein H is a numerical value expressed as H %, used directly for calculation without converting the percentage values into decimal form; and the PL obtained by substituting the parameters into the above formula is a calculated index value to reflect relative differences among different structural configuration states.

For example, in one embodiment, the hydrocarbon resin polymer has a number-average molecular weight (Mn) of 7,787 g/mol, a dispersity index PDI of 5.04, and the hydrogen atom content (H %) in reactive double bonds of 3.24%. In this embodiment, after substituting Mn as a numerical value of 7,787, PDI as a numerical value of 5.04, and H as a numerical value of 3.24 corresponding to its percentage form into the above calculation formula of PL, a PL value of 7,787×5.04×3.24/100=1,271.59 can be obtained.

In some embodiments, the hydrocarbon resin polymer can have a PL of 200 to 10,000. When the PL of the hydrocarbon resin polymer is within the above range, it can facilitate enhancement of peel strength performance of a cured resin body formed from the hydrocarbon resin polymer. In some embodiments, the PL of the hydrocarbon resin polymer may be 300 to 8,000, 400 to 7,000, or 500 to 6,000. In some embodiments, the PL of the hydrocarbon resin polymer may be 400, 500, 600, 1,000, 2,000, 3,000, or 4,000.

In order to simultaneously balance multiple properties of the hydrocarbon resin polymer, including rigidity and thermal performance, electrical performance, processability, and peel strength, the present disclosure further characterizes relative configuration relationships among the above properties by using ratios of different parameters. These ratios can be used to reflect whether the properties under different structural designs are maintained in a reasonable balance state, thereby helping to avoid situations in which excessive enhancement of a single property leads to deterioration of other properties

In some embodiments, a ratio (Rh/Fp) of an index Rh related to rigidity and thermal performance to an index Fp related to molecular weight distribution in the hydrocarbon resin polymer may be 5 to 250, preferably 10 to 200. When Rh/Fp is within the above range, the hydrocarbon resin polymer can maintain good solubility and processability while retaining a certain degree of rigidity and thermal performance. In some embodiments, Rh/Fp can be 20, 30, 40, 50, 60, 90, 120, or 150.

In some embodiments, a ratio (Rh/Ed) of an index Rh related to rigidity and thermal performance to an index Ed related to electrical performance in the hydrocarbon resin polymer may be between 5 to 250, preferably 10 to 200. When Rh/Ed is within the above range, the hydrocarbon resin polymer can maintain good dielectric properties while satisfying requirements for both thermal performance and rigidity. In some embodiments, Rh/Ed may be 20, 30, 40, 50, 60, 90, 120, or 150.

In some embodiments, a ratio (PL/Rh) of an index PL related to peel strength to an index Rh related to rigidity and thermal performance in the hydrocarbon resin polymer may be 80 to 1,750, preferably 290 to 1,300. When PL/Rh is within the above range, a cured resin body formed from the hydrocarbon resin polymer can maintain required structural rigidity and thermal stability while having good peel strength. In some embodiments, PL/Rh may be 200, 300, 400, 500, 600, 700, 900, or 1,000.

In some embodiments, the ratio (PL/Ed) of an index PL related to peel strength to an index Ed related to electrical performance in the hydrocarbon resin polymer may be 700 to 250,000, preferably 6,000 to 140,000. When PL/Ed is within the above range, a cured resin body formed from the hydrocarbon resin polymer can simultaneously exhibit good peel strength and electrical performance. In some embodiments, PL/Ed may be 7,000, 10,000, 15,000, 20,000, 30,000, 40,000, 50,000, 60,000, or 70,000.

In some embodiments, the hydrocarbon resin polymer may satisfy at least one of the following (I) to (IV), wherein Rh, Fp, Ed, and PL are as described above:

$$Rh / Fp = 5 to 250 ; \qquad ( I )$$

$$Rh / Ed = 5 to 250 ; \qquad ( II )$$

$$PL / Rh = 80 to 1 , 750 ; \\ and \qquad ( III )$$

$$PL / Ed = 700 to 250 , 0. \qquad ( IV )$$

When the hydrocarbon resin polymer satisfies one of (I) to (IV), the hydrocarbon resin polymer can achieve a good balance among electrical performance (dielectric performance), thermal performance, processability, and/or formation of a cured resin body having good peel strength, thereby meeting stringent requirements of applications such as high-speed and high-frequency circuit boards, copper clad laminates (CCL), resin coated copper (RCC), among others.

In summary, the hydrocarbon resin polymer according to the present disclosure can have good electrical performance, good thermal performance, high solubility, and/or good processability. In some embodiments, the hydrocarbon resin polymer of the present disclosure may further form a cured resin body having good peel strength. In some embodiments, the hydrocarbon resin polymer of the present disclosure can achieve a good balance among electrical performance (dielectric performance), thermal performance, processability, and formation of a cured resin body having good peel strength.

The disclosure also provides a method for manufacturing a hydrocarbon resin polymer. The hydrocarbon resin polymer manufactured by the method for manufacturing the hydrocarbon resin polymer of the present disclosure may be the above-mentioned hydrocarbon resin polymer, and thus details thereof are not repeated herein.

The method for manufacturing the hydrocarbon resin polymer of the present disclosure includes performing a polymerization process to form a hydrocarbon resin polymer from a mixture, wherein the mixture includes a monovinyl aromatic compound, a divinyl aromatic compound, and a compound represented by the following Formula (III),

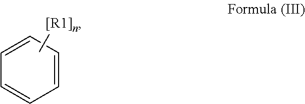

wherein R1 in Formula (III) is a C₁₋₄ alkyl group or a C₁₋₄ alkoxy group, and n is an integer selected from 0 to 3.

In some embodiments, examples of the monovinyl aromatic compound may include styrene, methylstyrene, α-methylstyrene, or ethylstyrene, but the present disclosure is not limited thereto.

In some embodiments, examples of the divinyl aromatic compound may include divinylbenzene, 1,3-diisopropenylbenzene, 1,2-bis(4-vinylphenyl) ethane, or p-isopropenyl-α-methylstyrene, but the present disclosure is not limited thereto.

In some embodiments, R1 in Formula (III) is a C₁₋₄ alkyl group or a C₁₋₄ alkoxy group; and n is an integer selected from 0 to 3. In some embodiments, R1 in Formula (III) is a C₁₋₄ alkyl group. In some embodiments, the compound represented by Formula (III) may be selected from the group consisting of benzene, toluene, xylene, ethylbenzene, anisole, isopropylbenzene, tert-butylbenzene, 1,2,3-trimethylbenzene, 1,2,4-trimethylbenzene, and 1,3,5-trimethylbenzene, but the present disclosure is not limited thereto.

In some embodiments, based on 100 mol % of the total amount of all components in the mixture, the content of the monovinyl aromatic compound may be 5 to 80 mol %. In some embodiments, based on 100 mol % of the total amount of all components in the mixture, the content of the monovinyl aromatic compound may be 12 to 70 mol %, 10 to 60 mol %, or 15 to 55 mol %. In some embodiments, based on 100 mol % of the total amount of all components in the mixture, the content of the divinyl aromatic compound may be 1 to 20 mol %. In some embodiments, based on 100 mol % of the total amount of all components in the mixture, the content of the divinyl aromatic compound may be 5 to 15 mol %, 4 to 12 mol %, or 3 to 10 mol %. In some embodiments, based on 100 mol % of the total amount of all components in the mixture, the content of the compound represented by Formula (III) may be 20 to 80 mol %. In some embodiments, based on 100 mol % of the total amount of all components in the mixture, the content of the compound represented by Formula (III) may be 25 to 77 mol %, 30 to 75 mol %, or 35 to 73 mol %.

In some embodiments, the mixture may further include a cyclic olefin compound, a linear olefin compound, a branched olefin compound, and/or a non-alkenyl-substituted aromatic compound. Examples of the cyclic olefin compound may include cyclopentene, cyclohexene, dicyclopentadiene, norbornene, ethylidene norbornene, vinyl norbornene, or norbornadiene, but the present disclosure is not limited thereto. Examples of the linear olefin compound may include ethylene, propylene, 1-butene, 1-hexene, and butadiene, but the present disclosure is not limited thereto. Examples of the branched olefin compound may include isobutylene, isoprene, and 2-methylhexene, but the present disclosure is not limited thereto. Examples of the non-alkenyl-substituted aromatic compound may include indene, methylindene, naphthalene, or methylnaphthalene, but the present disclosure is not limited thereto.

In some embodiments, based on 100 mol % of the total amount of all components in the mixture, the total content of the cyclic olefin compound, the linear olefin compound, the branched olefin compound, and/or the non-alkenyl-substituted aromatic compound may be 0 to 20 mol %. In some embodiments, based on 100 mol % of the total amount of all components in the mixture, the total content of the cyclic olefin compound, the linear olefin compound, the branched olefin compound, and/or the non-alkenyl-substituted aromatic compound may be 1 to 17 mol %, 3 to 15 mol %, or 5 to 12 mol %.

In some embodiments, the polymerization process may include adding a catalyst to the mixture. The catalyst may include titanium tetrachloride and/or a boron trifluoride complex. Examples of the boron trifluoride complex may include boron trifluoride tetrahydrofuran complex (BF₃-THF), boron trifluoride methanol complex (BF₃-MeOH), boron trifluoride hydrate (BF₃—H₂O), boron trifluoride diethyl ether complex (BF₃-OEt₂), boron trifluoride anisole complex (BF₃-PhOMe), boron trifluoride acetic acid complex (BF₃—AcOH), or any combination thereof, but the present disclosure is not limited thereto. In some embodiments, a molar ratio of the catalyst to the mixture may be 0.1 to 7:100. In some embodiments, the molar ratio of the catalyst to the mixture may be 0.2 to 6:100, 0.3 to 5:100, or 0.4 to 4.5:100, but the present disclosure is not limited thereto.

In some embodiments, the reaction temperature, the reaction time, and the ratio of raw materials to the catalyst of the polymerization process may affect the content distribution of various structural units (such as structural unit (A), structural unit (B), structural unit (C), structural unit (D), among others) in the formed hydrocarbon resin polymer. In some embodiments, the polymerization process may include a reaction temperature of 0 to 100° C. In some embodiments, the polymerization process may include a reaction temperature of 0 to 80° C., 0 to 60° C., 0 to 40° C., or 0 to 20° C. In some embodiments, a higher reaction temperature facilitates formation of structural unit (A); in contrast, when the reaction temperature is excessively low, an amount of formation of structural unit (A) may be reduced or structural unit (A) may be difficult to form. In some embodiments, the polymerization process may include a reaction temperature of 60 to 80° C., 40 to 60° C., or 30 to 40° C. In some embodiments, the polymerization process may include a reaction time of 0.5 to 10 hours. In some embodiments, the polymerization process may include a reaction time of 0.8 to 10 hours, 1 to 7 hours, or 1 to 5 hours. In some embodiments, a longer reaction time facilitates formation of structural unit (A); in contrast, when the reaction time is relatively short, an amount of formation of structural unit (A) may be reduced or structural unit (A) may be difficult to form. In some embodiments, a higher added amount of the catalyst facilitates formation of structural unit (A); in contrast, when the added amount of the catalyst is relatively low, an amount of formation of structural unit (A) may be reduced or structural unit (A) may be difficult to form.

The specific structure of the hydrocarbon resin polymer obtained by the method for manufacturing the hydrocarbon resin polymer of the present disclosure is as described above, and thus is not repeated herein. The hydrocarbon resin polymer obtained by the method for manufacturing the hydrocarbon resin polymer of the present disclosure may have good electrical performance, good thermal performance, high solubility, and/or good processability. In some embodiments, the hydrocarbon resin polymer obtained by the method for manufacturing the hydrocarbon resin polymer according to the present disclosure may further form a cured resin body having good peel strength. In some embodiments, the hydrocarbon resin polymer obtained by the method for manufacturing the hydrocarbon resin polymer according to the present disclosure may achieve a good balance among properties such as electrical performance (dielectric performance), thermal performance, processability, and formation of a cured resin body having good peel strength, among others.

Some embodiments of the present disclosure provide a resin composition, including the above-mentioned hydrocarbon resin polymer. In some embodiments, the resin composition is in a varnish form, suitable for electronic material applications, such as impregnation or coating processes for fibrous substrates.

In some embodiments, the resin composition may further include a solvent. The solvent may be an aromatic solvent, an aliphatic solvent, an alicyclic solvent, a halogenated hydrocarbon solvent, an ether solvent, an ester solvent, a ketone solvent, or a mixture thereof. Examples of the solvent may include, but are not limited to, toluene, xylene, mesitylene, ethylbenzene, isopropylbenzene, trifluoromethylbenzene, fluorobenzene, chlorobenzene, bromobenzene, iodobenzene, dichloroethane, chloroform, cyclohexane, methylcyclohexane, n-hexane, heptane, p-menthane, tetrahydrofuran, ethyl acetate, anisole, methyl ethyl ketone, methyl isobutyl ketone, propylene glycol monomethyl ether acetate (PGMEA), or any combination thereof. In some embodiments, based on 100 parts by weight of the hydrocarbon resin polymer in the resin composition, the resin composition of the present disclosure may include 5 to 350 parts by weight of an organic solvent. In some embodiments, the resin composition of the present disclosure may further include an optional photoinitiator, an optional inhibitor, an optional crosslinking agent, an optional leveling agent, or a combination thereof.

The resin composition including the hydrocarbon resin polymer of the present disclosure may have good solubility, improved processability, good film-forming property, good electrical performance, thermal performance, and/or may form a cured resin body having good peel strength.

Some embodiments of the present disclosure provide a curable composite material, including the above-mentioned hydrocarbon resin polymer. In some embodiments, the curable composite material may include a fibrous substrate and the hydrocarbon resin polymer formed on the fibrous substrate. In some embodiments, the curable composite material may be in a prepreg form.

In some embodiments, a manufacturing method of the curable composite material may include the following steps: providing a resin composition including the hydrocarbon resin polymer of the present disclosure; impregnating a fibrous substrate with the resin composition to form a curable material; and heating the curable material under required heating conditions (for example, heating at about 100° C. to about 180° C. for about 1 minute to about 15 minutes), so as to semi-cure the resin composition on the fibrous substrate, thereby obtaining the curable composite material in a semi-cured state.

Examples of the fibrous substrate may include glass fiber cloth, aramid cloth, polyester cloth, glass fiber nonwoven fabric, aramid nonwoven fabric, polyester nonwoven fabric, pulp paper, printer paper, other suitable material, or any combination thereof, but the present disclosure is not limited thereto. In some embodiments, the fibrous substrate may be a glass fiber cloth having a dielectric loss tangent (Df) less than or equal to 0.0030, wherein the dielectric loss tangent (Df) is measured at a frequency of about 28 GHz (Df @ 28 GHz).

In some embodiments, the curable composite material of the present disclosure may have a dielectric loss tangent (Df @ 28 GHz) of less than 0.01. In some embodiments, the curable composite material of the present disclosure may have a dielectric loss tangent (Df @ 28 GHz) of less than or equal to 0.00250, less than or equal to 0.00220, less than or equal to 0.00200, less than or equal to 0.00180, or less than or equal to 0.00170.

Some embodiments of the present disclosure provide a cured resin body formed from the above-mentioned hydrocarbon resin polymer. In some embodiments, the cured resin body is a copper clad laminate (CCL), which may be formed from the above-mentioned curable composite material through a hot-pressing process.

Specifically, in some embodiments, the cured resin body is produced by laminating the above-mentioned curable composite material (i.e., a semi-cured sheet) with copper foil, and heating the same to 210° C. through a hot-pressing process so as to produce the cured resin body.

Some embodiments of the present disclosure provide another cured resin body and a resin product including the cured resin body. In some embodiments, the resin product is a resin coated copper foil (RCC).

In some embodiments, the resin product may include a base film and the cured resin body formed on the base film. In some embodiments, the resin product may include one or more base films and the cured resin body formed on at least one surface of at least one base film. In some embodiments, the resin product may be obtained by coating the above-mentioned resin composition on at least one base film to form a curable resin layer, and curing the resin composition under required heating conditions to form the cured resin body, thereby obtaining the resin product.

In some embodiments, the above-mentioned resin product (for example, a resin-coated metal foil) may be further laminated with one or more layers of material, and another resin product is thereby formed through a hot-pressing process. In some embodiments, a base film may include a metal foil. In some embodiments, the metal foil may include a copper foil.

There is no particular limitation on a method for coating the resin composition onto at least one surface of the metal foil. Specifically, the coating method includes: introducing the resin composition into a coating apparatus; and coating the resin composition onto at least one surface of the metal foil to a desired thickness. Examples of the coating apparatus include a comma coater, a knife coater, a lip coater, a roll coater, an extrusion coater, a reverse coater, a transfer roll coater, a gravure coater, a spray coater, among others, but the present disclosure is not limited thereto.

Hot-pressing conditions in the hot-pressing process may be appropriately set according to a thickness of a metal foil laminate to be produced and a type of the resin composition used in a prepreg or a resin-coated copper foil. For example, the hot-pressing conditions may be set such that a temperature is 180 to 210° C., a pressure is 1.0 to 3.0 MPa, and a time is 60 to 180 minutes.

A curable composite material, a cured resin body, and/or a resin product including the hydrocarbon resin polymer of the present disclosure may have good electrical performance and/or thermal performance. Further, a layer or film including the hydrocarbon resin polymer in the curable composite material, the cured resin body, and/or the resin product has good peel strength, thereby enhancing reliability of the curable composite material, the cured resin body, and/or the resin product.

One or more embodiments of the present disclosure will now be illustrated in detail with reference to the following examples. However, these examples are merely used to illustrate embodiments of the present disclosure and are not intended to limit the scope of the embodiments of the present disclosure.

### Preparation of Hydrocarbon Resin Polymers 1 to 20

### Polymerization Procedure

The raw materials listed in Table 1 were added under nitrogen into a 1 L four-neck straight jacketed reactor equipped with a single-layer four-blade flat paddle, and the raw materials were stirred using the four-blade flat paddle at a stirring speed set to 400 rpm to form a mixture. At the temperature shown in Table 1, the catalyst in the amount shown in Table 1 was added into the mixture at a rate of 0.25 mL/min using a syringe pump. After completion of the catalyst addition, the reaction was carried out for the reaction time shown in Table 1, and then isopropanol was added to terminate the reaction so as to obtain a polymer mother liquor. The polymer mother liquor finally appeared colorless.

### Purification Procedure

First, the polymer mother liquor was filtered to remove impurities and insoluble matter. The polymer mother liquor was washed using a mechanical stirrer at a rotation speed of 500 rpm. Under mechanical stirring at 500 rpm, the polymer mother liquor was slowly added dropwise into isopropanol in an amount of 5 times by weight via an addition funnel, thereby obtaining a white crude resin product. Solid-liquid separation was carried out by suction filtration to obtain a white solid. The white solid was re-dissolved in tetrahydrofuran to form a new mother liquor, and precipitation was carried out again with isopropanol (a weight ratio of the mother liquor to isopropanol being 1:5). After filtration, a purer white resin solid was obtained. Finally, the solid was washed with methanol to remove impurities and residual isopropanol and heated with stirring under vacuum to remove solvents, thereby obtaining white powdery hydrocarbon resin polymers 1 to 20 of the present disclosure.

The raw materials, reaction temperatures, reaction times, and catalyst amounts used to form hydrocarbon resin polymers 1 to 20 of the present disclosure are listed in Table 1 below. Except that the catalyst used in hydrocarbon resin polymer 16 was titanium tetrachloride, the catalysts used in hydrocarbon resin polymers 1 to 15 and 17 to 20 were all boron trifluoride complexes. The mol % of each raw material listed in Table 1 refers to, based on 100 mol % of the total amount of all components (excluding the catalyst) in the mixture, the content of each component. The mol % of the catalyst listed in Table 1 refers to, based on 100 mol % of the mixture, an amount of the catalyst relative to the mixture. The xylene mixture listed in Table 1 refers to a mixture including 40 to 65 wt. % of m-xylene, 15 to 20 wt. % of o-xylene, less than 20 wt. % of p-xylene, and 15 to 20 wt. % of ethylbenzene.

TABLE 1

| Raw Material | 1 | 2 | 3 | 4 | 5 | 6 | 7 | 8 |
|---|---|---|---|---|---|---|---|---|
| Dicyclopentadiene | 7.74 | 6.58 | 6.57 | 6.57 | 6.58 | 8.96 | 7.15 | 5.23 |
| (mol %) | | | | | | | | |
| Styrene (mol %) | 25.94 | 27.1 | 25.52 | 25.13 | 27.1 | 36.88 | 21.5 | 15.7 |
| Ethylstyrene (mol %) | 2.28 | 2.28 | 2.98 | 3.16 | 2.28 | 3.11 | 3.25 | 3.01 |
| Divinylbenzene (mol %) | 3.17 | 3.17 | 4.14 | 4.38 | 3.17 | 4.31 | 4.51 | 4.19 |
| Toluene (mol %) | 60.86 | 60.86 | 60.79 | 60.76 | 60.86 | -- | -- | -- |
| Xylene mixture (mol %) | -- | -- | -- | -- | -- | 46.74 | 63.58 | |
| p-Xylene (mol %) | -- | -- | | -- | -- | | | 71.87 |
| Reaction temperature | 20 | 20 | 20 | 20 | 20 | 25 | 70 | 25 |
| (° C.) | | | | | | | | |
| Reaction time (hour) | 2 | 2 | 2 | 2 | 2 | 2 | 3 | 2 |
| Catalyst (mol %) | 0.78 | 0.78 | 0.78 | 0.78 | 0.79 | 0.757 | 0.145 | 0.182 |
| Raw Material | 9 | 10 | 11 | 12 | 13 | 14 | 15 | 16 |
| Dicyclopentadiene | 8.96 | 9.47 | 10.07 | 9.47 | -- | -- | -- | -- |
| (mol %) | | | | | | | | |
| 1-Hexene (mol %) | -- | | | -- | | 7.37 | -- | |
| Isoprene (mol %) | -- | | | -- | -- | -- | 7.37 | |
| Indene (mol %) | -- | -- | | -- | 6.56 | -- | -- | |
| Styrene (mol %) | 36.88 | 39.01 | 46.48 | 38.99 | 22.37 | 24.69 | 24.69 | 45.84 |
| Ethylstyrene (mol %) | 3.11 | 3.28 | 3.49 | 2.68 | 4.37 | 2.17 | 2.17 | 3.11 |
| Divinylbenzene (mol %) | 4.31 | 4.56 | 4.85 | 4.63 | 6.07 | 3.01 | 3.01 | 4.32 |
| Toluene (mol %) | -- | -- | | -- | 60.64 | 62.76 | 62.76 | -- |
| Xylene mixture (mol %) | -- | | | -- | -- | | -- | 46.73 |
| p-Xylene (mol %) | 46.74 | -- | | | | | | -- |
| Mesitylene (mol %) | -- | 43.68 | | -- | | | | |
| Trifluoromethylbenzene | -- | -- | 40.1 | | | | | -- |
| (mol %) | | | | | | | | |
| Methoxybenzene | -- | -- | | 44.23 | -- | -- | -- | |
| (mol %) | | | | | | | | |
| Reaction temperature | 15 | 25 | 15 | 25 | 20 | 25 | 20 | 20 |
| (° C.) | | | | | | | | |
| Reaction time (hour) | 2 | 2 | 2 | 2 | 2 | 2 | 2 | 1 |
| Catalyst (mol %) | 0.757 | 0.740 | 0.782 | 4.600 | 0.777 | 0.407 | 0.407 | 0.31 |
| Raw Material | 17 | 18 | 19 | 20 | | | | |
| Dicyclopentadiene | -- | | 8.32 | 7.67 | | | | |
| (mol %) | | | | | | | | |
| Styrene (mol %) | 17.45 | 17.45 | 34.25 | 31.58 | | | | |
| Ethylstyrene (mol %) | 5.28 | 5.28 | 2.89 | 2.66 | | | | |
| Divinylbenzene (mol %) | 7.33 | 7.33 | 4.01 | 3.69 | | | | |
| Toluene (mol %) | 69.94 | 69.94 | | -- | | | | |
| p-Menthane (mol %) | -- | -- | 50.54 | -- | | | | |
| Mesitylene (mol%) | -- | | | 54.39 | | | | |
| Reaction temperature | 30 | 30 | 20 | 20 | | | | |
| (° C.) | | | | | | | | |
| Reaction time (hour) | 1 | 1 | 1 | 2 | | | | |
| Catalyst (mol %) | 0.280 | 0.250 | 0.986 | 0.909 | | | | |

### [Measurement of Dielectric Constant of Compounds Represented by Formula (III)]

Measurement equipment included a high-precision LCR meter, a liquid dielectric measurement cell, a constant-temperature water bath (set at 25° C.), and a syringe for injecting samples.

In order to measure a dielectric constant (ε) of a compound represented by Formula (III), a parallel-plate capacitor might be used, and a capacitance (C) when filled with a liquid was compared with a capacitance (C₀) when filled with air or vacuum, wherein ε=C/C₀. Specifically, capacitance was first measured using air (ε≈1) to calibrate the capacitor so as to obtain C₀. Subsequently, a pure liquid sample (for example, HPLC grade) was injected into the liquid dielectric measurement cell, and it was ensured that no air bubbles were present. Capacitance C was measured within a frequency range of 1 kHz to 1 MHz while maintaining the temperature constant, and the dielectric constant & was calculated accordingly. In order to improve measurement accuracy, the measurement was repeated multiple times and an average value was taken. Dielectric constant measurement results of the compounds represented by Formula (III) used for manufacturing hydrocarbon resin polymers 1 to 20 and comparative compounds thereof are listed in Table 2 below.

TABLE 2

| Compound represented by Formula (III) | Dielectric constant |
|---|---|
| Toluene | 2.38 |
| Xylene mixture | 2.57 |
| p-Xylene | 2.27 |
| Mesitylene | 2.38 |
| Trifluoromethylbenzene | 9.2 |
| Methoxybenzene | 4.66 |
| p-Menthane | 2.38 |

### [Measurement of Physical/Chemical Properties of Hydrocarbon Resin Polymers 1 to 20]

### [Measurement of Hydrogen Atom Content in Reactive Double Bonds]

The hydrocarbon resin polymers 1 to 20 were respectively dissolved in deuterated chloroform (CDCl₃). NMR (JEOL, JNM-ECZ400S/L1) was used to respectively measure hydrogen atom content in double bonds and reactive double bonds of the hydrocarbon resin polymers 1 to 20. Specifically, the hydrogen atom content in reactive double bonds was calculated by dividing a sum of integral values of hydrogens in reactive double bonds by a sum of integral values of all hydrogens, thereby obtaining the hydrogen atom content in reactive double bonds of the hydrocarbon resin polymers 1 to 20.

### [Measurement of Number-Average Molecular Weight (Mn) and Polymer Dispersity Index (PDI)]

Using polystyrene as a standard, the number-average molecular weight (Mn) and the polymer dispersity index (PDI) of the hydrocarbon resin polymers 1 to 20 were measured by gel permeation chromatography (GPC) (Waters APC; column: Waters Acquity XT 900).

Specifically, 5 mL of tetrahydrofuran (THF) was respectively added to 0.01 g of each of the hydrocarbon resin polymers 1 to 20 to prepare samples of the hydrocarbon resin polymers 1 to 20. After filtering the samples of the hydrocarbon resin polymers 1 to 20 through a 0.22 μm filter, instrumental analysis was performed to obtain the number-average molecular weight (Mn) and the polymer dispersity index (PDI) of the hydrocarbon resin polymers 1 to 20. The PDI is the ratio of the weight-average molecular weight (Mw) to the number-average molecular weight (Mn) of the hydrocarbon resin polymer (Mw/Mn). The weight-average molecular weight (Mw) can be calculated from the PDI and the number-average molecular weight (Mn). Measurement results of the dispersity index (PDI), the number-average molecular weight (Mn), and the hydrogen atom content in reactive double bonds of the hydrocarbon resin polymers 1 to 20 are listed in Table 3 below.

TABLE 3

| Hydrocarbon | Hydrogen atom | Number-average | Dispersity |
|---|---|---|---|
| resin | content in reactive | molecular weight | index |
| polymer No. | double bonds (%) | (g/mol) | (PDI) |
| 1 | 3.24 | 7,787 | 5.04 |
| 2 | 2.30 | 6,368 | 9.53 |
| 3 | 3.22 | 10,480 | 8.5 |
| 4 | 2.95 | 12,159 | 8.33 |
| 5 | 3.09 | 6,550 | 8.8 |
| 6 | 3.84 | 3,212 | 12.64 |
| 7 | 3.02 | 3,131 | 11.41 |
| 8 | 3.93 | 12,252 | 6.87 |
| 9 | 3.63 | 6,061 | 18.5 |
| 10 | 3.21 | 5,015 | 6.39 |
| 11 | 3.28 | 4,054 | 33.94 |
| 12 | 2.05 | 500 | 1.36 |
| 13 | 3.60 | 7,977 | 12.98 |
| 14 | 2.30 | 11,779 | 12.3 |
| 15 | 2.07 | 4,496 | 27.1 |
| 16 | 1.42 | 2,655 | 4.18 |
| 17 | 6.19 | 15,743 | 14.3 |
| 18 | 6.08 | 17,502 | 13.59 |
| 19 | 2.02 | 10,068 | 10.43 |
| 20 | 2.36 | 10,320 | 4.85 |

### [Structural Analysis of Hydrocarbon Resin Polymers 1 to 20]

0.05 g of each of the hydrocarbon resin polymers 1 to 20 was weighed out, and 1.0 g of deuterated chloroform (CDCl₃) was added to prepare Samples 1 to 20. Subsequently, using a nuclear magnetic resonance apparatus (NMR; JEOL, JNM-ECZ400S), at 25° C., 13C-NMR and ¹H-NMR of Samples 1 to 10 and 12 to 20 and ¹⁹F-NMR of Sample 11 were measured. Based on the measured ¹³C-NMR, ¹H-NMR, and ¹⁹F-NMR, the structural compositions of the hydrocarbon resin polymers 1 to 20 were determined. The results indicate that the hydrocarbon resin polymers 1 to 20 include a structural unit (A) derived from a compound represented by Formula (III), a structural unit (B) derived from a monovinyl aromatic compound, a structural unit (C) derived from a divinyl aromatic compound, and a structural unit (D) derived from a cyclic olefin compound, a linear olefin compound, a branched olefin compound, and/or a non-alkenyl-substituted aromatic compound.

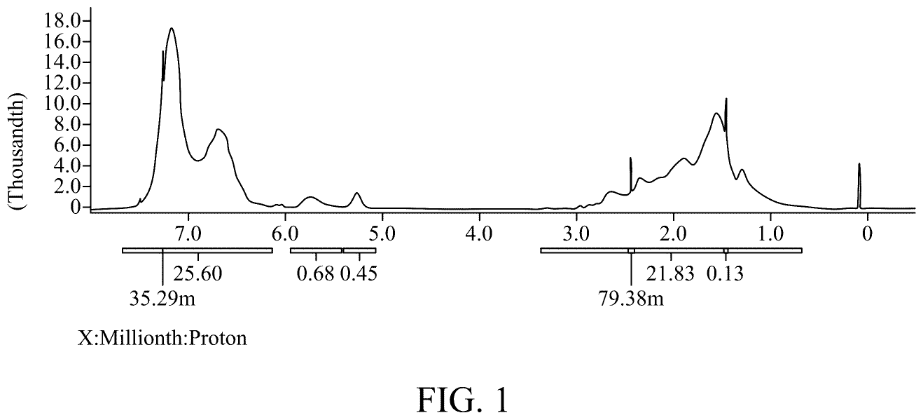

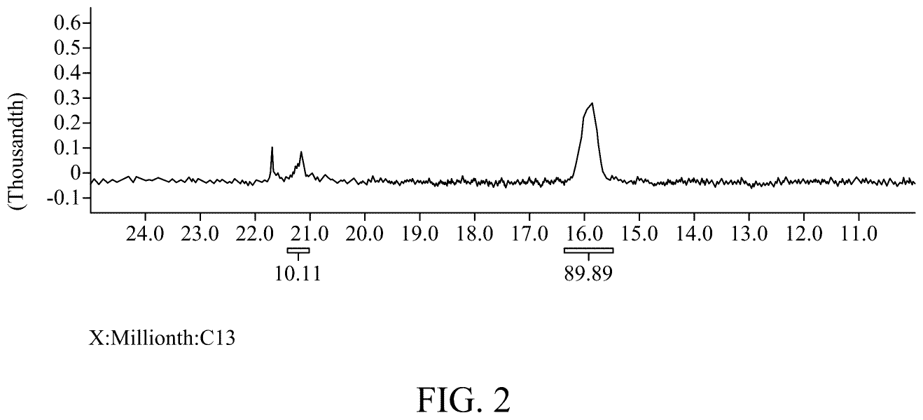

Hereinafter, the structural unit (A) of hydrocarbon resin polymer 2 is taken as an example to illustrate calculation methods of contents of the structural units (A) to (D). FIG. 1 is a ¹H-NMR spectrum of hydrocarbon resin polymer 2. FIG. 2 is a ¹³C-NMR spectrum of hydrocarbon resin polymer 2. The following calculation methods of contents of the structural units (A) to (D) in hydrocarbon resin polymer 2 are illustrated by taking a structural unit derived from ethylstyrene (EVB) as an example to explain calculation of a structural unit derived from toluene. This is merely one specific embodiment of a quantification procedure used in the present disclosure and is used to exemplify one feasible quantitative analysis method. It is not intended to indicate that the technical solution of the present application must include ethylstyrene as a monomer source, nor to limit that subsequent calculation or analysis of units derived from toluene and other structural units must use the structural unit derived from ethylstyrene (EVB) as a sole reference. Quantitative concepts and methods disclosed herein are not limited to a specific monomer or a specific structural unit.

In practice, a person having ordinary skill in the art may, according to actually used monomer types (for example, a vinyl aromatic compound, a divinyl aromatic compound, or a combination thereof), select corresponding characteristic chemical shift peaks in 1H-NMR or ¹³C-NMR for integration analysis, so as to quantify relative or absolute contents of each structural unit.

For example, if structural units derived from different sources in a hydrocarbon resin polymer are respectively defined as unit A, unit B, unit C, and unit D, a person skilled in the art may perform signal integration based on characteristic peak positions corresponding to each structural unit in an NMR spectrum, thereby calculating contents of each unit (for example, a, b, c, and d), and performing normalization on obtained values as required, such that the total amount of the structural units is 100 mol %.

First, FIG. 1 (¹H-NMR spectrum) was used to calculate relative proportions of structural units derived from dicyclopentadiene, structural units derived from styrene, structural units derived from ethylstyrene, and structural units derived from divinylbenzene in the entire hydrocarbon resin polymer 2. Subsequently, FIG. 2 (¹³C-NMR) was used to integrate signals at 15.0 to 16.5 ppm (representing structural units derived from ethylstyrene) and 19.6 to 20.4 ppm (representing structural units derived from toluene). Using the ratio of the two integration values, relative proportions of structural units derived from ethylstyrene and structural units derived from toluene in hydrocarbon resin polymer 2 were obtained. Further, based on the above-mentioned relative proportion relationship, contents of all structural units were normalized so that the total thereof is 100 mol %, thereby obtaining contents of each structural unit.

Specifically, based on the calculation using FIG. 1 (¹H-NMR spectrum) for hydrocarbon resin polymer 2, and taking the total content of the structural units derived from dicyclopentadiene, the structural units derived from styrene, the structural units derived from ethylstyrene, and the structural units derived from divinylbenzene in hydrocarbon resin as 100 mol %, the content of the structural unit derived from ethylstyrene was 11 mol %. Next, according to FIG. 2 (¹³C-NMR), the ratio of the structural unit derived from toluene to the structural unit derived from ethylstyrene was 10.11:89.89. Therefore, after normalizing contents of all structural units, the content of the unit derived from toluene was calculated to be 1.24 mol % (11 mol %×10.11-89.89).

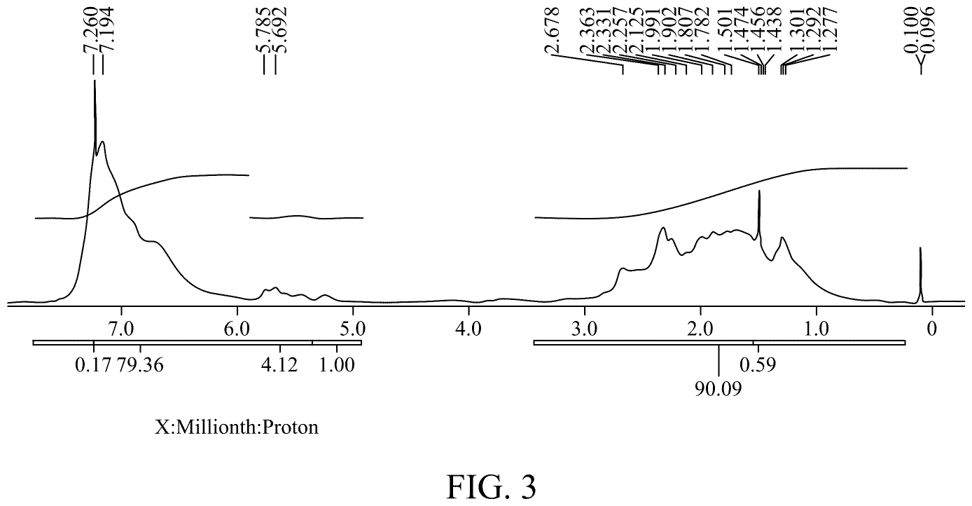

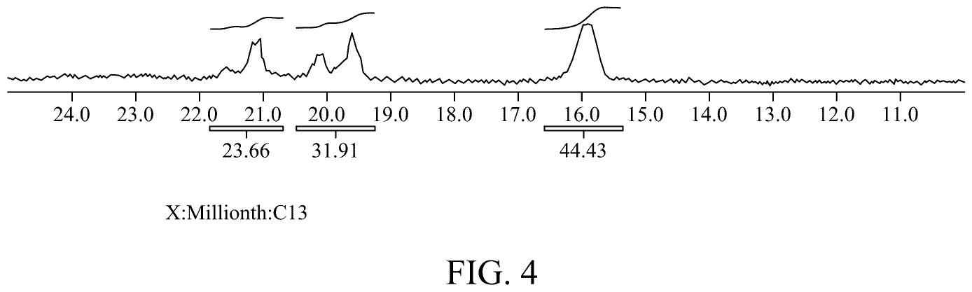

Hereinafter, the structural unit (A) of hydrocarbon resin polymer 7 is taken as an example to illustrate calculation methods of contents of the structural units (A) to (D). FIG. 3 is a ¹H-NMR spectrum of hydrocarbon resin polymer 7. FIG. 4 is a ¹³C-NMR spectrum of hydrocarbon resin polymer 7.

First, FIG. 3 (¹H-NMR spectrum) was used to calculate relative proportions of the structural units derived from dicyclopentadiene, the structural units derived from styrene, the structural units derived from ethylstyrene, and the structural units derived from divinylbenzene in the entire hydrocarbon resin polymer 7. Subsequently, FIG. 4 (¹³C-NMR) was used to integrate signals at 15.0 to 16.5 ppm (representing structural units derived from ethylstyrene) and 19.1 to 20.1 ppm and 20.6 to 21.6 ppm (representing structural units derived from xylene). Using the ratio of the integrations, relative proportions of the structural units derived from ethylstyrene and the structural units derived from xylene in hydrocarbon resin polymer 7 were obtained. Specifically, based on the calculation using FIG. 3 (¹H-NMR spectrum) for hydrocarbon resin polymer 7, and taking the total content of structural units derived from dicyclopentadiene, the structural units derived from styrene, the structural units derived from ethylstyrene, and the structural units derived from divinylbenzene as 100 mol %, the content of the structural unit derived from ethylstyrene was 14 mol %. Next, according to FIG. 4 (¹³C-NMR), the ratio of the structural unit derived from xylene to the structural unit derived from ethylstyrene was (23.66+31.91): 44.43. Therefore, after normalizing contents of all structural units, the content of the unit derived from xylene was calculated to be 8.7%

$$( 14 \% \times 55.57 \div ( 44.43 \times 2 ) ) .$$

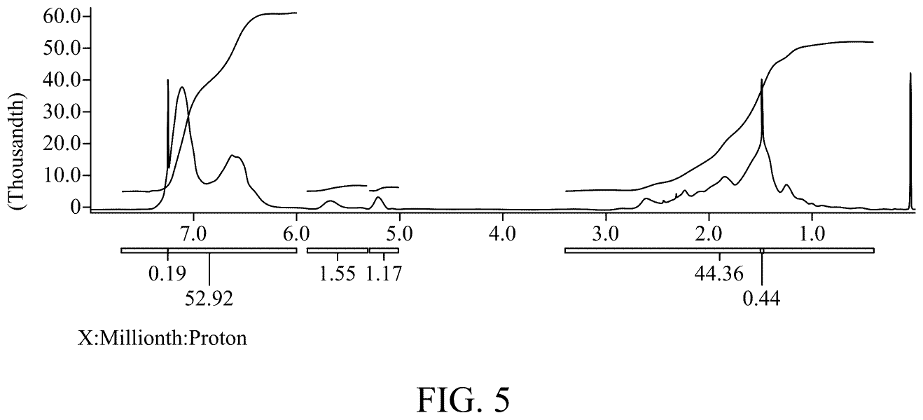

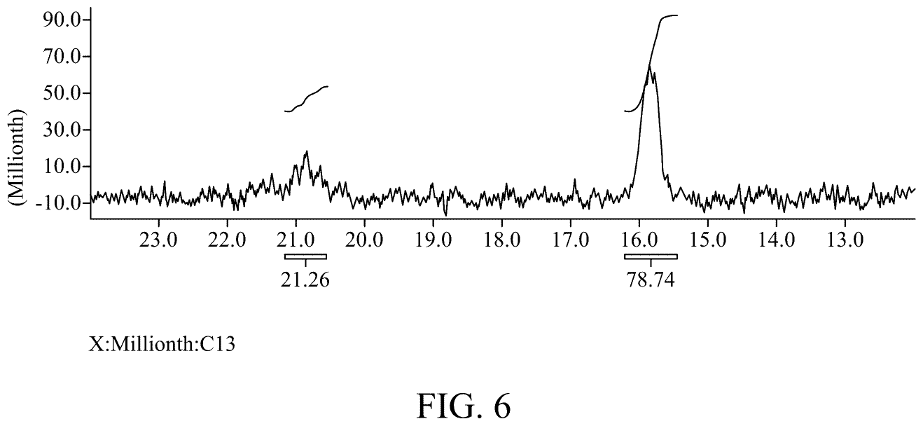

Hereinafter, the structural unit (A) of hydrocarbon resin polymer 10 is taken as an example to illustrate calculation methods of contents of the structural units (A) to (D). FIG. 5 is a ¹H-NMR spectrum of hydrocarbon resin polymer 10. FIG. 6 is a ¹³C-NMR spectrum of hydrocarbon resin polymer 10.

First, FIG. 5 (¹H-NMR spectrum) was used to calculate relative proportions of structural units derived from dicyclopentadiene, structural units derived from styrene, structural units derived from ethylstyrene, and structural units derived from divinylbenzene in the entire hydrocarbon resin polymer 10. Subsequently, FIG. 6 (¹³C-NMR) was used to integrate signals at 15.0 to 16.5 ppm (representing the structural unit derived from ethylstyrene) and at 20.0 to 21.7 ppm (representing the structural unit derived from mesitylene). Using the ratio of the integration values of the two signals, the relative proportion between the structural unit derived from ethylstyrene and the structural unit derived from mesitylene in the hydrocarbon resin polymer 10 was obtained. Further, based on the above-mentioned relative proportion relationship, contents of all structural units were normalized such that the total thereof was 100 mol %, thereby obtaining contents of the respective structural units.

Specifically, based on calculation using FIG. 5 (¹H-NMR spectrum) for the hydrocarbon resin polymer 10, and taking the total content of the structural units derived from dicyclopentadiene, the structural units derived from styrene, the structural units derived from ethylstyrene, and the structural units derived from divinylbenzene as 100 mol %, the content of the structural unit derived from ethylstyrene was 11 mol %. Next, according to FIG. 6 (¹³C-NMR), the ratio of the structural unit derived from mesitylene to the structural unit derived from ethylstyrene was 21.26:78.74. Therefore, by normalizing contents of all structural units, the content of the structural unit derived from mesitylene was calculated to be 0.99 mol % (11 mol %×21.26÷(78.74× 3)).

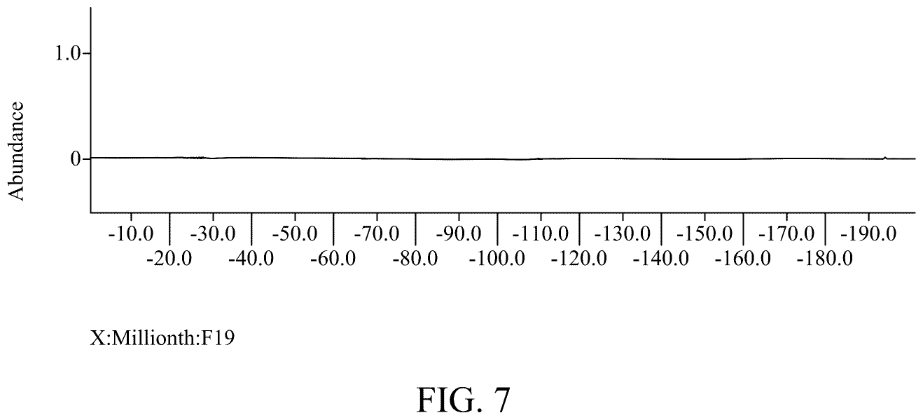

FIG. 7 is a ¹⁹F-NMR spectrum of the hydrocarbon resin polymer 11. As can be seen from FIG. 7, the content of the structural unit (A) in the hydrocarbon resin polymer 11 is 0 mol %.

Hereinafter, the hydrocarbon resin polymer 12 is taken as an example of the structural unit (A) to illustrate calculation methods of contents of the structural units (A) to (D). The structural unit (A) of the hydrocarbon resin polymer 12 was derived from anisole. In the present disclosure, GC-FID (gas chromatography-flame ionization detector) was used to quantify the content of the structural unit (A) derived from anisole.

Specifically, a raw material mixture used in a polymerization process for forming the hydrocarbon resin polymer 12 was first diluted tenfold with isopropanol (IPA) and filtered to form a “pre-reaction raw material sample”. Then, the “pre-reaction raw material sample” was analyzed under the following GC conditions to determine the proportion of each component. GC conditions: injection volume: 1 μL; split ratio: 10:1; injector temperature: 210° C.; column oven heating conditions: holding at 40° C. for 1 minute, heating to 200° C. at 10° C./min and holding for 1 minute, then heating to 250° C. at 20° C./min and holding for 1 minute; column: DB-ALC2, 30 μm*530 μm*2.0 μm; detector: FID; detector temperature: 250° C. As described above, after reaction of the raw material mixture in the polymerization process, a polymer mother liquor was formed, wherein the polymer mother liquor included the hydrocarbon resin polymer 12 and residual raw materials. Next, the polymer mother liquor was taken, diluted tenfold with isopropanol (IPA) and filtered to form a “post-reaction residual raw material sample”, and analyzed under the same GC conditions to determine the proportion of each component therein. The conversion rate of each component in the hydrocarbon resin polymer 12 was calculated using proportions of each component in the “pre-reaction raw material sample” and the “post-reaction residual raw material sample” used to form the hydrocarbon resin polymer 12 of the present disclosure, and results are listed in the table below. For example, the content of anisole was 37.89583075 wt % in the pre-reaction raw material sample and 6.399680 wt % in the post-reaction residual raw material sample. Accordingly, the conversion rate was 83.11% ((37.896 wt %-6.400 wt %)/37.896 wt %*100%).

| | Pre-reaction | Post-reaction | |
|---|---|---|---|
| | raw material | residual raw | Conversion |
| | sample | material sample | rate (%) |
| Anisole (wt %) | 37.896 | 6.400 | 83.11 |
| Styrene (wt %) | 40.853 | 1.275 | 96.88 |
| Dicyclopentadiene | 11.825 | 0.000 | 100.00 |
| (wt %) | | | |
| Divinylbenzene (wt %) | 5.866 | 0.191 | 96.75 |
| Ethylstyrene (wt %) | 3.560 | 0.000 | 100.00 |

According to the conversion rates listed in the above table and amounts of respective raw materials of the hydrocarbon resin polymer 12 in Table 1, it could be calculated that the hydrocarbon resin polymer 12 included 40.33 mol % of the structural unit derived from anisole, 41.43 mol % of the structural unit derived from styrene, 10.39 mol % of the structural unit derived from dicyclopentadiene, 4.91 mol % of the structural unit derived from divinylbenzene, and 2.94 mol % of the structural unit derived from ethylstyrene.

### [Measurement of Crosslinkable Structural Unit Content (C1)]

By analyzing structures of the hydrocarbon resin polymers 1 to 20 using NMR (JEOL, JNM-ECZ400S/L1) and GPC (Waters), with CDCl₃ as a solvent and using a resonance line of CDCl₃ as an internal standard, contents of crosslinkable structural units (C1) in the hydrocarbon resin polymers 1 to 20 were determined.

The contents of the structural unit (A), the structural unit (B), the structural unit (C), the structural unit (D), the crosslinkable structural unit (C1), the crosslinked structural unit (C2), the first structural unit (D1), and the second structural unit (D2), and the total content of the structural unit (C) and the structural unit (D), in the hydrocarbon resin polymers 1 to 20 are listed in Tables 4 to 6 below.

TABLE 4

| Hydrocarbon Resin | | | | | | | |
|---|---|---|---|---|---|---|---|
| Polymer No. | 1 | 2 | 3 | 4 | 5 | 6 | 7 |
| Structural unit (A) | 1 | 1 | 2 | 2 | 2 | 0.1 | 8.7 |
| (mol %) | | | | | | | |
| Units derived | 66 | 66 | 65 | 65 | 68 | 64.9 | 53.3 |
| from styrene | | | | | | | |
| (mol %) | | | | | | | |
| Units derived from | 11 | 11 | 11 | 11 | 10 | 11 | 11 |
| ethylstyrene (mol %) | | | | | | | |
| Structural unit (B) | 77 | 77 | 76 | 76 | 78 | 75.9 | 64.3 |
| (mol %) | | | | | | | |
| Structural unit (C1) | 11 | 10 | 12 | 12 | 10 | 14 | 5 |
| (mol %) | | | | | | | |
| Structural unit (C2) | 7 | 7 | 7 | 7 | 7 | 6 | 14 |
| (mol %) | | | | | | | |
| Structural unit (C) | 18 | 17 | 19 | 19 | 17 | 20 | 19 |
| (mol %) | | | | | | | |
| Structural unit (D1) | 4 | 5 | 3 | 3 | 3 | 4 | 8 |
| (mol %) | | | | | | | |
| Structural unit (D2) | 0 | 0 | 0 | 0 | 0 | 0 | 0 |
| (mol %) | | | | | | | |
| Structural unit (D) | 4 | 5 | 3 | 3 | 3 | 4 | 8 |
| (mol %) | | | | | | | |
| Total of structural | 22 | 22 | 23 | 23 | 20 | 24 | 27 |
| unit (C) and | | | | | | | |
| structural unit (D) | | | | | | | |
| (mol %) | | | | | | | |

TABLE 5

| Hydrocarbon | | | | | | | |
|---|---|---|---|---|---|---|---|
| Resin | | | | | | | |
| Polymer No. | 8 | 9 | 10 | 11 | 12 | 13 | 14 |
| Structural unit (A) (mol %) | 1 | 0.35 | 1 | 0 | 40.33 | 0.1 | 0.1 |
| Units derived from styrene (mol %) | 51 | 66.65 | 74 | 63 | 41.43 | 32.9 | 77.9 |
| Units derived from ethylstyrene (mol %) | 18 | 11 | 8 | 13 | 2.94 | 20 | 8 |
| Structural unit (B) (mol %) | 69 | 77.65 | 82 | 76 | 44.37 | 52.9 | 85.9 |
| Structural unit (C1) (mol %) | 17 | 13 | 11 | 11 | 4.91 | 15 | 12 |
| Structural unit (C2)( mol %) | 12 | 6 | 3 | 10 | 0 | 19 | 2 |
| Structural unit (C) (mol %) | 29 | 19 | 14 | 21 | 4.91 | 34 | 14 |
| Structural unit (D1) (mol %) | 1 | 3 | 3 | 3 | 10.39 | 13 | 0 |
| Structural unit (D2) (mol %) | 0 | 0 | 0 | 0 | 0 | 0 | 0 |
| Structural unit (D) (mol %) | 1 | 3 | 3 | 3 | 10.39 | 13 | 0 |
| Total of structural unit (C) and structural unit | 30 | 22 | 17 | 24 | 15.30 | 47 | 14 |
| (D) (mol %) | | | | | | | |

TABLE 6

| Hydrocarbon Resin | | | | | | |
|---|---|---|---|---|---|---|
| Polymer No. | 15 | 16 | 17 | 18 | 19 | 20 |
| Structural unit (A) | 1.5 | 0.1 | 0.12 | 0.1 | 0 | 0 |
| (mol %) | | | | | | |
| Units derived | 89.5 | 81.4 | 40.5 | 45.42 | 76 | 67 |
| from styrene | | | | | | |
| (mol %) | | | | | | |
| Units derived from | 3.1 | 6.85 | 11.8 | 20.18 | 8 | 12 |
| ethylstyrene (mol %) | | | | | | |
| Structural unit (B) | 92.6 | 88.25 | 52.3 | 65.6 | 84 | 79 |
| (mol %) | | | | | | |
| Structural unit (C1) | 3.9 | 6.05 | 29.03 | 28.85 | 8 | 9 |
| (mol %) | | | | | | |
| Structural unit (C2) | 0 | 5.6 | 18.55 | 5.45 | 7 | 11 |
| (mol %) | | | | | | |
| Structural unit (C) | 3.9 | 11.65 | 47.58 | 34.3 | 15 | 20 |
| (mol %) | | | | | | |
| Structural unit (D1) | 0 | 0 | 0 | 0 | 1 | 1 |
| (mol %) | | | | | | |
| Structural unit (D2) | 2 | 0 | 0 | 0 | 0 | 0 |
| (mol %) | | | | | | |
| Structural unit (D) | 2 | 0 | 0 | 0 | 1 | 1 |
| (mol %) | | | | | | |
| Total of structural | 5.9 | 11.65 | 47.58 | 34.3 | 16 | 21 |
| unit (C) and | | | | | | |
| structural unit (D) | | | | | | |
| (mol %) | | | | | | |

According to data in Tables 3 to 6 and the following equations, Fp, Rh, Ed, PL, Rh/Fp, Rh/Ed, PL/Rh, and PL/Ed of the hydrocarbon resin polymers 1 to 20 were calculated, and calculated results are listed in Tables 7 to 10 below.

$$Fp = 1 / PDI \\ Rh = 0.9 * H + 0.1 * ( C 1 + D 1 ) \\ Ed = 0.9 * Fp + 0.1 * Ms \\ Ms = ( A + B + 3 * D 2 ) / 1000 \\ PL = Mn * PDI * H / 100 \\ Mw = Mn * PDI$$

TABLE 7

| | Hydrocarbon Resin Polymer No. | | | | |
|---|---|---|---|---|---|
| | 1 | 2 | 3 | 4 | 5 |
| Fp | 0.1984 | 0.1049 | 0.1176 | 0.1200 | 0.1136 |
| Mw | 39246.48 | 60687.04 | 89080.00 | 101284.47 | 57640.00 |
| Ms | 0.0780 | 0.0780 | 0.0780 | 0.0780 | 0.0800 |
| Rh | 4.42 | 3.57 | 4.40 | 4.16 | 4.08 |
| Ed | 0.1864 | 0.1022 | 0.1137 | 0.1158 | 0.1103 |
| PL | 1271.59 | 1395.80 | 2868.38 | 2987.89 | 1779.92 |
| Rh/Fp | 22.26 | 34.02 | 37.38 | 34.61 | 35.90 |
| Rh/Ed | 23.69 | 34.92 | 38.69 | 35.87 | 36.99 |
| PL/Rh | 287.95 | 390.98 | 652.20 | 719.11 | 436.34 |
| PL/Ed | 6822.86 | 13652.39 | 25231.50 | 25792.55 | 16141.10 |

TABLE 8

| | Hydrocarbon Resin Polymer No. | | | | |
|---|---|---|---|---|---|
| | 6 | 7 | 8 | 9 | 10 |
| Fp | 0.0791 | 0.0876 | 0.1456 | 0.0541 | 0.1565 |
| Mw | 40599.68 | 35724.71 | 84171.24 | 112128.50 | 32045.85 |
| Ms | 0.0760 | 0.0730 | 0.0700 | 0.0780 | 0.0830 |
| Rh | 5.26 | 4.02 | 5.34 | 4.87 | 4.29 |
| Ed | 0.0788 | 0.0862 | 0.1380 | 0.0564 | 0.1491 |
| PL | 1560.65 | 1078.53 | 3307.93 | 4073.63 | 1028.03 |
| Rh/Fp | 66.48 | 45.84 | 36.67 | 90.09 | 27.40 |
| Rh/Ed | 66.74 | 46.61 | 38.67 | 86.27 | 28.75 |
| PL/Rh | 296.72 | 268.48 | 619.81 | 836.53 | 239.79 |
| PL/Ed | 19804.59 | 12515.11 | 23969.75 | 72165.21 | 6892.82 |

TABLE 9

| | Hydrocarbon Resin Polymer No. | | | | |
|---|---|---|---|---|---|
| | 11 | 12 | 13 | 14 | 15 |
| Fp | 0.0295 | 0.7353 | 0.0770 | 0.0813 | 0.0369 |
| Mw | 137592.76 | 680.00 | 103541.46 | 144881.70 | 121841.60 |
| Ms | 0.0760 | 0.0845 | 0.0530 | 0.0860 | 0.1001 |
| Rh | 4.36 | 3.39 | 6.04 | 3.27 | 2.25 |
| Ed | 0.0341 | 0.6702 | 0.0746 | 0.0818 | 0.0432 |
| PL | 4518.55 | 13.95 | 3727.49 | 3332.28 | 2522.12 |
| Rh/Fp | 147.83 | 4.61 | 61.53 | 40.22 | 61.06 |
| Rh/Ed | 127.67 | 5.06 | 63.51 | 39.99 | 52.13 |
| PL/Rh | 1037.41 | 4.11 | 786.39 | 1019.05 | 1119.45 |
| PL/Ed | 132441.17 | 20.81 | 49941.32 | 40751.49 | 58354.97 |

TABLE 10

| | Hydrocarbon Resin Polymer No. | | | | |
|---|---|---|---|---|---|
| | 16 | 17 | 18 | 19 | 20 |
| Fp | 0.2392 | 0.0699 | 0.0736 | 0.0959 | 0.2062 |
| Mw | 11097.90 | 225124.90 | 237852.18 | 105009.20 | 50052.00 |
| Ms | 0.0884 | 0.0524 | 0.0657 | 0.0840 | 0.079 |
| Rh | 1.88 | 8.47 | 8.36 | 2.72 | 3.12 |
| Ed | 0.2241 | 0.0682 | 0.0728 | 0.0947 | 0.1935 |
| PL | 157.81 | 13923.98 | 14461.41 | 2121.20 | 1181.20 |
| Rh/Fp | 7.88 | 121.11 | 113.57 | 28.35 | 15.15 |
| Rh/Ed | 8.41 | 124.22 | 114.80 | 28.70 | 16.15 |
| PL/Rh | 83.73 | 1644.01 | 1730.46 | 780.4 | 378.1 |
| PL/Ed | 704.06 | 204226.55 | 198658.97 | 22401.50 | 6105.6 |

### [Solubility Test of Hydrocarbon Resin Polymers 1 to 20]

The hydrocarbon resin polymers 1 to 20 were respectively dissolved in toluene or methyl ethyl ketone (MEK) to form a solution having a viscosity lower than 1,000 cP. A maximum content of the hydrocarbon resin polymer forming the solution having a viscosity lower than 1,000 cP was measured. When the content of the hydrocarbon resin polymer in the solution was greater than 65 wt %, the hydrocarbon resin polymer indicated excellent solubility; when the content of the hydrocarbon resin polymer in the solution was 45 to 65 wt %, the hydrocarbon resin polymer indicated good solubility; and when the content of the hydrocarbon resin polymer in the solution was less than 45 wt %, the hydrocarbon resin polymer indicated poor solubility. Solubility test results of the hydrocarbon resin polymers 1 to 20 were listed in Table 11 below.

TABLE 11

| Hydrocarbon Resin | |
|---|---|
| Polymer No. | Solubility |
| 1 | Good |
| 2 | Good |
| 3 | Good |
| 4 | Good |
| 5 | Good |
| 6 | Good |
| 7 | Good |
| 8 | Good |
| 9 | Poor |
| 10 | Good |
| 11 | Poor |
| 12 | Excellent |
| 13 | Poor |
| 14 | Poor |
| 15 | Poor |
| 16 | Good |
| 17 | Poor |
| 18 | Poor |
| 19 | Good |
| 20 | Good |

### [Electrical Performance Test of Hydrocarbon Resin Polymers 1 to 20]

15 g of each of the hydrocarbon resin polymers 1 to 20 was dissolved in 15 g of toluene to form a mixture. The mixture was stirred until the hydrocarbon resin polymer was completely dissolved to form resin compositions 1 to 20, and the clarity of the resin compositions 1 to 20 was observed. Glass fiber cloth (Asahi 2116, Dk/Df at 28 GHz=3.3/0.0030) was immersed in each of the resin compositions 1 to 20 for about 16 hours to form curable composite materials 1 to 20. The curable composite materials 1 to 20 were baked at 170° C. for 10 minutes to form cured resin bodies 1 to 20. A dielectric constant/loss factor (Dk/Df) at 28 GHz and R.C. % of the cured resin bodies 1 to 20 were measured using network analyzer software (network analyzer Keysight P5007A, SCR). Measurement results are listed in Table 12 below.

$$Resin content ( R . C . ) \% = ( \frac{Weight after baking - Weight of glass fiber cloth}{Weight after baking} ) \times 100 \%$$

TABLE 12

| Cured Resin | | Resin |
|---|---|---|
| Body No. | Dk/Df@28 GHz | content % |
| 1 | 2.910/0.001800 | 64.3% |
| 2 | 3.057/0.001837 | 58.8% |
| 3 | 3.110/0.001650 | 63.7% |
| 4 | 2.890/0.001600 | 69.9% |
| 5 | 2.860/0.001500 | 68.3% |
| 6 | 2.770/0.001900 | 67.0% |
| 7 | 2.870/0.001500 | 62.2% |
| 8 | 2.640/0.001500 | 56.1% |
| 9 | 2.640/0.001500 | 56.1% |
| 10 | 2.750/0.002017 | 54.1% |
| 11 | 2.620/0.002152 | 64.5% |
| 12 | Not measured/0.008120 | 61.0% |
| 13 | Not measured/0.001605 | 73.7% |
| 14 | Not measured/0.002261 | 50.8% |
| 15 | Not measured/0.002374 | 49.2% |
| 16 | Not measured/0.002371 | 51.5% |
| 17 | Not measured/0.002375 | 51.9% |
| 18 | Not measured/0.002374 | 51.4% |
| 19 | 3.010/0.001820 | 60.9% |
| 20 | 2.900/0.002080 | 55.8% |

100 parts by weight of each of the hydrocarbon resin polymers 1 to 20 were mixed with 100 parts by weight of toluene, 15 parts by weight of a toughening agent, 9 parts by weight of DVB, 0.27 parts by weight of a peroxide, and 30 parts by weight of a filler, and zirconia beads were used for grinding until the filler was uniformly dispersed, thereby preparing resin solutions 1 to 20. The toughening agent was Ricon 100; the filler might be SVC purchased from Admatch or SS-10 purchased from Tokuyama. The peroxide might be perbutyl P purchased from NOF CORPORATION.

Glass fiber cloth (Asahi 2116, Dk/Df at 28 GHz=3.3/0.0030) was respectively impregnated in resin solutions 1 to 20, and then baked at 160° C. for 7 minutes to obtain prepregs 1 to 20. Two prepregs were stacked together with copper foil (RTF, Hoz (18 μm), Rz: 3.5 μm), and a silane adhesive agent (KBM503) was coated between the copper foil and the prepreg, followed by pressing at 210° C. for 3 hours to obtain substrate Samples 1 to 20. The following property measurements were performed on substrate Samples 1 to 20.

### [Measurement of Glass Transition Temperature (Tg)]

Substrate Samples 1 to 20 were heated from 25° C. to 270° C. at a rate of 3° C./min. The glass transition temperature (Tg) of cured resin bodies 1 to 20 was measured using dynamic mechanical analysis (DMA, TA/Q800). The test frequency was 1 Hz. The glass transition temperature (Tg) of cured resin bodies 1 to 20 was obtained from the tan delta peak in the DMA plot. The measurement results are listed in Table 13 below.

### [Measurement of Percent of Thermal Expansion (PTE)]

A thermomechanical analyzer (Thermomechanical Analysis, model: Q400, manufacturer: TA) was used to analyze substrate Samples 1 to 20 according to the following steps.

Cycle 1 to Cycle 4 were sequentially performed, with Cycle 3 as the measurement reference. Dimensions at different temperatures (50 and 260° C.) were recorded to calculate the percentage of dimensional change. Cycle 1: under an N₂ atmosphere, equilibrated at 25° C., held for 1 minute, and heated from 25° C. to 270° C. at 20° C./min. Cycle 2: cooled from 270° C. to 25° C. at 20° C./min, held for 1 minute, and equilibrated at 25° C. Cycle 3: heated from 25° C. to 270° C. at 10° C./min. Cycle 4: cooled from 270° C. to 25° C. at 20° C./min. The measurement results are listed in Table 13 below.

TABLE 13

| Substrate | | |
|---|---|---|
| Sample No. | PTE (%) | Tg (° C.) |
| 1 | 3.800 | 144.00 |
| 2 | 5.300 | 152.00 |
| 3 | 4.200 | 171.00 |
| 4 | 4.700 | 173.00 |
| 5 | 5.200 | 147.00 |
| 6 | 5.400 | 147.00 |
| 7 | 5.422 | 146.60 |
| 8 | 5.129 | 152.20 |
| 9 | 5.100 | 152.00 |
| 10 | 4.699 | 159.60 |
| 11 | 5.097 | 157.70 |
| 12 | Not measured | Not measured |
| 13 | 4.070 | 201.72 |
| 14 | 4.220 | 145.80 |
| 15 | 7.123 | 123.80 |
| 16 | 5.547 | 116.92 |
| 17 | 2.630 | 225.87 |
| 18 | 1.877 | 221.96 |
| 19 | 4.968 | 147.00 |
| 20 | 4.505 | 148.00 |

### [Measurement of Electrical Performance]

A network analyzer software (network analyzer Keysight P5007A, SCR) was used to measure the dielectric constant/loss factor (Dk/Df) and R.C. % of substrate Samples 1 to 20 at 28 GHz. The measurement results are listed in Table 14 below.

### [Measurement of Resin Flow]

After substrate Samples 1 to 20 were formed, a length measurement tool (such as a ruler) was used to measure the edge of the resin layer of substrate Samples 1 to 20 to determine the resin flow length. Specifically, the substrate sample included a copper foil layer and a resin layer including resin solutions 1 to 20, wherein resin solutions 1 to 20 partially overflowed during the hot-press curing stage (i.e., extended beyond the glass fiber cloth). The resin flow length was defined as the average length of resin solutions 1 to 20 extending beyond the edge of the glass fiber cloth. A resin flow length less than or equal to 0.5 cm was rated as excellent, a resin flow length greater than 0.5 cm and less than or equal to 2.0 cm was rated as good, and a resin flow length greater than 2.0 cm was rated as poor.

The measurement results are listed in Table 14 below.

TABLE 14

| Substrate | | | Resin Flow | Resin |
|---|---|---|---|---|
| Sample No. | Dk/Df@28 GHz | R.C.(%) | Length (cm) | Flow |
| 1 | 2.990/0.002301 | 64.3 | 1.8 | Good |
| 2 | 3.120/0.002321 | 66.3 | 0.5 | Excellent |
| 3 | 2.940/0.002260 | 65.7 | 0.6 | Good |
| 4 | 2.880/0.002244 | 66.9 | 0.8 | Good |
| 5 | 2.990/0.002180 | 67.5 | 0.3 | Excellent |
| 6 | 2.930/0.001820 | 62.5 | 0.4 | Excellent |
| 7 | 3.080/0.002370 | 58.8 | 0.4 | Excellent |
| 8 | 2.730/0.002160 | 66.6 | 0.3 | Excellent |
| 9 | 2.600/0.001647 | 76.3 | 0.3 | Excellent |
| 10 | 2.840/0.002390 | 63.7 | 0.2 | Excellent |
| 11 | 2.810/0.002340 | 71.1 | 0.2 | Excellent |
| 12 | 2.960/0.004320 | 17.95 | 6.5 | Poor |
| 13 | 3.060/0.002579 | 67.79 | 0.2 | Excellent |
| 14 | 2.910/0.001850 | 66.85 | 0.5 | Excellent |
| 15 | 2.820/0.001844 | 67.91 | 0.5 | Excellent |
| 16 | 3.122/0.002926 | 48.28 | 0.8 | Good |
| 17 | 2.571/0.001896 | 72.32 | 0.3 | Excellent |
| 18 | 2.879/0.001982 | 69.33 | 0.1 | Excellent |
| 19 | 2.930/0.002530 | 60.94 | 0.1 | Excellent |
| 20 | 2.880/0.002350 | 58.84 | 0.4 | Excellent |

### [Peeling Strength Test]

The peeling strength of substrate Samples 1 to 20 having a size of 12.7 mm×20 mm was measured using a SHIMADZU AG-Xplus at a peel rate of 50.8 mm/min. The measurement results are listed in Table 15 below.

TABLE 15

| Substrate Sample No. | Peel Strength (lbf/inch) |
|---|---|
| 1 | 2.30 |
| 2 | 2.50 |
| 3 | 2.60 |
| 4 | 2.40 |
| 5 | 2.20 |
| 6 | 2.50 |
| 7 | 2.40 |
| 8 | 2.60 |
| 9 | 2.60 |
| 10 | 2.70 |
| 11 | 2.70 |
| 12 | 0.01 |
| 13 | 2.48 |
| 14 | 2.30 |
| 15 | 2.55 |
| 16 | 0.27 |
| 17 | 1.41 |
| 18 | 1.85 |
| 19 | 2.35 |
| 20 | 2.35 |

As can be seen from Tables 2, 11, and 14, when the hydrocarbon resin polymer includes a structural unit derived from an aromatic compound having a dielectric constant of less than 4, the hydrocarbon resin polymer has better solubility and resin flow performance. That is, when the hydrocarbon resin polymer includes a structural unit derived from an aromatic compound having a dielectric constant of less than 4, the hydrocarbon resin polymer has better processability.

As can be seen from Tables 3 to 6 and Table 11, a hydrocarbon resin polymer (hydrocarbon resin polymer 12) having a lower weight-average molecular weight (e.g., <10,000 g/mol) exhibits excellent solubility; a hydrocarbon resin polymer having a second lower weight-average molecular weight (e.g., 10,000 to 100,000 g/mol) exhibits good solubility; and a hydrocarbon resin polymer having a higher weight-average molecular weight (e.g., >100,000 g/mol) exhibits poor solubility. As can be seen from Tables 7 to 10 and Table 14, in terms of film-forming property, a hydrocarbon resin polymer having a weight-average molecular weight within a certain range (e.g., >10,000 g/mol) can exhibit better resin flow performance.

As can be seen from Tables 7 to 11, a hydrocarbon resin polymer having a higher Fp exhibits excellent or good solubility; whereas a hydrocarbon resin polymer having a lower Fp exhibits poor solubility.

As can be seen from Tables 7 to 10 and Table 13, a hydrocarbon resin polymer having a higher Rh exhibits better thermal performance and/or thermal stability (such as Tg and percent of thermal expansion). A hydrocarbon resin polymer having a lower Rh exhibits inferior thermal performance and/or thermal stability (such as Tg and percent of thermal expansion).

As can be seen from Tables 7 to 10 and Table 14, a hydrocarbon resin polymer having an Ed within a specific range (e.g., 0.02 to 0.3) exhibits better electrical performance (Df@28 GHz). However, a hydrocarbon resin polymer having an Ed outside the above-mentioned range exhibits inferior electrical performance.

As can be seen from Tables 7 to 10 and Table 15, a hydrocarbon resin polymer having a PL within a specific range (e.g., 200 to 10,000) exhibits better peeling strength. However, a hydrocarbon resin polymer having a PL outside the above-mentioned range exhibits inferior peeling strength.

It is apparent that, in addition to having good electrical performance and thermal performance, the hydrocarbon resin polymer of the present disclosure can also have good processability. A resin composition including the hydrocarbon resin polymer of the present disclosure can form a cured resin body having good peeling strength. A resin product including the above-mentioned cured resin body can have good electrical performance and thermal performance, and/or reliability.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A hydrocarbon resin polymer, comprising:
a structural unit (A) represented by the following Formula (I) or Formula (II);
a structural unit (B) derived from a monovinyl aromatic compound; and
a structural unit (C) derived from a divinyl aromatic compound, 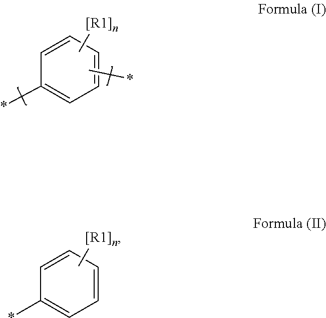
wherein R1 in Formula (I) and Formula (II) is a C₁₋₄ alkyl group or a C₁₋₄ alkoxy group;
n is an integer selected from 0 to 3; and
* represents a connecting site connected to another group or unit.

2. The hydrocarbon resin polymer as claimed in claim 1, wherein, based on 100 mol % of a total amount of all units in the hydrocarbon resin polymer, a content of the structural unit (A) is 0.01 to 10 mol %.

3. The hydrocarbon resin polymer as claimed in claim 2, wherein the content of the structural unit (A) is 0.1 to 5 mol %.

4. The hydrocarbon resin polymer as claimed in claim 1, wherein Formula (I) and Formula (II) are derived from an aromatic compound having a dielectric constant of less than 4.

5. The hydrocarbon resin polymer as claimed in claim 1, wherein R1 in Formula (I) and Formula (II) is a C₁₋₄ alkyl group.

6. The hydrocarbon resin polymer as claimed in claim 1, wherein, based on 100 mol % of a total amount of all units in the hydrocarbon resin polymer, a content of the structural unit (B) is 15 to 95 mol %.

7. The hydrocarbon resin polymer as claimed in claim 1, wherein, based on 100 mol % of a total amount of all units in the hydrocarbon resin polymer, a content of the structural unit (C) is 1 to 80 mol %.

8. The hydrocarbon resin polymer as claimed in claim 1, wherein the hydrocarbon resin polymer further comprises:
a structural unit (D) being a first structural unit (D1) or a second structural unit (D2),
wherein the first structural unit (D1) is derived from a cyclic olefin compound or a non-alkenyl-substituted aromatic compound; and
the second structural unit (D2) is derived from a linear olefin compound or a branched olefin compound,
wherein the non-alkenyl-substituted aromatic compound refers to an aromatic compound having a substituent that is not an alkenyl group.

9. The hydrocarbon resin polymer as claimed in claim 8, comprising the second structural unit (D2).

10. The hydrocarbon resin polymer as claimed in claim 8, wherein, based on 100 mol % of a total amount of all units in the hydrocarbon resin polymer, a content of the second structural unit (D2) is 0.1 to 80 mol %.

11. The hydrocarbon resin polymer as claimed in claim 8, wherein, based on 100 mol % of a total amount of all units in the hydrocarbon resin polymer, a content of the structural unit (D) is 0.1 to 80 mol %.

12. The hydrocarbon resin polymer as claimed in claim 8, wherein, based on 100 mol % of a total amount of all units in the hydrocarbon resin polymer, a total content of the structural unit (C) and the structural unit (D) is greater than or equal to 5 mol %.

13. The hydrocarbon resin polymer as claimed in claim 8, wherein the structural unit (C) comprises a crosslinkable structural unit (C₁) and a crosslinked structural unit (C2): 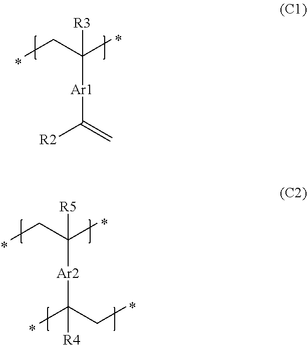
wherein R2, R3, R4, and R5 are each independently hydrogen or a C₁₋₂₀ alkyl group;
Ar1 and Ar2 are phenylene groups; and
* represents a connecting site connected to another group or unit, wherein, based on 100 mol % of a total amount of all units in the hydrocarbon resin polymer, the hydrocarbon resin polymer has an Rh of 0.5 to 15,
wherein Rh is calculated according to the following equation:
$$Rh = 0.9 * H + 0.1 * ( C 1 + D 1 ) ,$$
wherein H, C₁, and D1 are numerical values expressed as H %, C1%, and D1%, respectively, used directly for calculation without converting the percentage values into decimal form;
H % is a hydrogen atom content in reactive double bonds of the hydrocarbon resin polymer;
C1% is, based on 100 mol % of a total amount of all units in the hydrocarbon resin polymer, a content of the crosslinkable structural unit (C1); and
D1% is, based on 100 mol % of a total amount of all units in the hydrocarbon resin polymer, a content of the first structural unit (D1).

14. The hydrocarbon resin polymer as claimed in claim 13, wherein the hydrocarbon resin polymer has an Rh of 3 to 10.

15. The hydrocarbon resin polymer as claimed in claim 13, wherein the hydrocarbon resin polymer satisfies at least one of the following (I) to (IV):
(I) Rh/Fp is 5 to 250;
(II) Rh/Ed is 5 to 250;
(III) PL/Rh is 80 to 1,750; and
(IV) PL/Ed is 700 to 250,000,
wherein Rh-0.9*H+0.1*(C1+D1);
$$Fp = 1 / PDI ; \\ Ed = 0.9 * Fp + 0.1 * Ms ; \\ PL = Mn * PDI * H / 100 ; \\ Ms = ( A + B + 3 * D 2 ) / 1000 ;$$
Mn is a number-average molecular weight (Mn) of the hydrocarbon resin polymer;
PDI is a ratio of a weight-average molecular weight (Mw) to the number-average molecular weight (Mn);
A, B, H, C1, D1, and D2 are numerical values expressed as A %, B %, H %, C1%, D1%, and D2%, respectively, used directly for calculation without converting the percentage values into decimal form;
H % is a hydrogen atom content in reactive double bonds of the hydrocarbon resin polymer;
C1% is, based on 100 mol % of a total amount of all units in the hydrocarbon resin polymer, a content of the crosslinkable structural unit (C1);
D1% is, based on 100 mol % of a total amount of all units in the hydrocarbon resin polymer, a content of the first structural unit (D1);
A % is, based on 100 mol % of a total amount of all units in the hydrocarbon resin polymer, a content of the structural unit (A);
B % is, based on 100 mol % of a total amount of all units in the hydrocarbon resin polymer, a content of the structural unit (B); and
D2% is, based on 100 mol % of a total amount of all units in the hydrocarbon resin polymer, a content of the second structural unit (D2).

16. The hydrocarbon resin polymer as claimed in claim 15, wherein the hydrocarbon resin polymer has a Rh/Ed of 10 to 200.

17. The hydrocarbon resin polymer as claimed in claim 15, wherein the hydrocarbon resin polymer has a PL/Rh of 290 to 1,300.

18. The hydrocarbon resin polymer as claimed in claim 15, wherein the hydrocarbon resin polymer has a PL/Ed of 6,000 to 140,000.

19. The hydrocarbon resin polymer as claimed in claim 15, wherein the hydrocarbon resin polymer has a Rh/Fp of 10 to 200.

20. The hydrocarbon resin polymer as claimed in claim 8, wherein the hydrocarbon resin polymer has an Ed of 0.02 to 0.3,
wherein Ed is calculated according to the following equation:
$$Ed = 0.9 * Fp + 0.1 * Ms ,$$
wherein Fp is calculated according to the following equation:
$$Fp = 1 / PDI ,$$
Ms is calculated according to the following equation:
$$Ms = ( A + B + 3 * D 2 ) / 1000 ,$$
wherein PDI is a ratio of a weight-average molecular weight (Mw) to a number-average molecular weight (Mn);
A, B, and D2 are numerical values expressed as A %, B %, and D2%, respectively, used directly for calculation without converting the percentage values into decimal form;
A % is, based on 100 mol % of a total amount of all units in the hydrocarbon resin polymer, a content of the structural unit (A);
B % is, based on 100 mol % of a total amount of all units in the hydrocarbon resin polymer, a content of the structural unit (B); and
D2% is, based on 100 mol % of a total amount of all units in the hydrocarbon resin polymer, a content of the second structural unit (D2).

21. The hydrocarbon resin polymer as claimed in claim 20, wherein the hydrocarbon resin polymer has an Ed of 0.03 to 0.2.

22. The hydrocarbon resin polymer as claimed in claim 1, wherein the structural unit (C) comprises a crosslinkable structural unit (C1) and a crosslinked structural unit (C2): 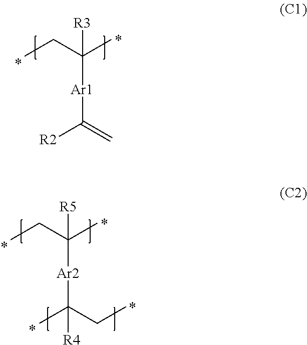
wherein R2, R3, R4, and R5 are each independently hydrogen or a C₁₋₂₀ alkyl group;
Ar1 and Ar2 are phenylene groups; and
* represents a connecting site connected to another group or unit,
wherein, based on 100 mol % of a total amount of all units in the hydrocarbon resin polymer, a content of the crosslinkable structural unit (C₁) is 1 to 30 mol %.

23. The hydrocarbon resin polymer as claimed in claim 1, wherein a hydrogen atom content in reactive double bonds of the hydrocarbon resin polymer is less than 10%.

24. The hydrocarbon resin polymer as claimed in claim 23, wherein the hydrogen atom content in reactive double bonds of the hydrocarbon resin polymer is 3% to 7%.

25. The hydrocarbon resin polymer as claimed in claim 1, wherein a weight-average molecular weight (Mw) of the hydrocarbon resin polymer is 10,000 to 150,000 g/mol.

26. The hydrocarbon resin polymer as claimed in claim 1, wherein the hydrocarbon resin polymer has an Fp of 0.02 to 1.0,
wherein Fp is calculated according to the following equation:
$$Fp = 1 / PDI ,$$
wherein PDI is a ratio of a weight-average molecular weight (Mw) to a number-average molecular weight (Mn) of the hydrocarbon resin polymer.

27. The hydrocarbon resin polymer as claimed in claim 26, wherein the hydrocarbon resin polymer has an Fp of 0.1 to 1.0.

28. The hydrocarbon resin polymer as claimed in claim 1, wherein the hydrocarbon resin polymer has a PL of 200 to 10,000,
wherein PL is calculated according to the following equation:
$$PL = Mn * PDI * H / 100 ,$$
wherein Mn is a number-average molecular weight (Mn) of the hydrocarbon resin polymer;
PDI is a ratio of a weight-average molecular weight (Mw) to the number-average molecular weight (Mn);
H is a numerical value expressed as H %, used directly for calculation without converting the percentage value into decimal form; and
H % is a hydrogen atom content in reactive double bonds of the hydrocarbon resin polymer.

29. The hydrocarbon resin polymer as claimed in claim 28, wherein the hydrocarbon resin polymer has a PL of 400 to 10,000.

30. A method for manufacturing a hydrocarbon resin polymer as claimed in claim 1, comprising:
performing a polymerization process to form a hydrocarbon resin polymer from a mixture,
wherein the mixture comprises:
a monovinyl aromatic compound;
a divinyl aromatic compound; and
a compound represented by the following Formula (III), 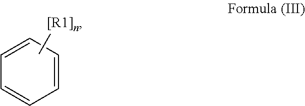
wherein R1 in Formula (III) is a C₁₋₄ alkyl group or a C₁₋₄ alkoxy group; and
n is an integer selected from 0 to 3.

31. A resin composition, comprising the hydrocarbon resin polymer as claimed in claim 1.

32. A curable composite material, comprising the hydrocarbon resin polymer as claimed in claim 1.

33. A cured resin body, which is formed from the hydrocarbon resin polymer as claimed in claim 1.

34. A resin product, comprising the cured resin body as claimed in claim 33.
